(19) United States
(12) Patent Application Publication
(10) Pub. No.: US 2025/0360920 A1
(43) Pub. Date: Nov. 27, 2025

(54) COLLISION DETERMINATION APPARATUS AND COLLISION DETERMINATION PROGRAM PRODUCT

(71) Applicants: DENSO CORPORATION, Kariya-city (JP); J-QuAD DYNAMICS Inc., Tokyo (JP); TOYOTA JIDOSHA KABUSHIKI KAISHA, Toyota-shi (JP)

(72) Inventors: Shogo MATSUNAGA, Tokyo (JP); Shotaro YAMAZAKI, Atsugi-shi (JP)

(21) Appl. No.: 19/217,628

(22) Filed: May 23, 2025

(30) Foreign Application Priority Data
May 27, 2024 (JP) 2024-085726

(51) Int. Cl. B60W 30/095; B60W 30/165

(52) U.S. Cl. CPC B60W 30/0956; B60W 30/165; B60W 2520/10; B60W 2520/14; B60W 2540/18; B60W 2552/53; B60W 2554/20; B60W 2554/402; B60W 2554/4041; B60W 2554/4042; B60W 2554/801

(57) ABSTRACT

A collision determination apparatus calculates an estimated first movement route of an own vehicle in a three-dimensional coordinate system. The three-dimensional coordinate system is defined to have a first axis representing distance in a width direction of the own vehicle, a second axis representing distance in a direction of travel of the own vehicle, and a third axis representing elapsed time from a current time. In response to determination that (i) the own vehicle is turning around a turning center point while following the detected object and (ii) the detected object is a preceding vehicle in front of the own vehicle, the collision determination apparatus calculates, as the estimated second movement route of the detected object, a turning trajectory of the detected object around the turning center point of the own vehicle in the three-dimensional coordinate system.

### CROSS REFERENCE TO RELATED APPLICATION

This application is based on and claims the benefit of priority from Japanese Patent Application No. 2024-085726 filed on May 27, 2024, the disclosure of which is incorporated in its entirety herein by reference.

### TECHNICAL FIELD

The present disclosure relates to collision determination apparatuses and collision determination program products for preventing a collision of an own vehicle with other objects.

### BACKGROUND

Japanese Patent Application Publication No. 2020-8288 discloses one of known collision determination apparatuses. The collision determination apparatus disclosed in the patent publication expresses, based on various information acquired from vehicular devices installed in an own vehicle, an estimated movement route of the own vehicle and an estimated movement route of a detected object in a predetermined three-dimensional coordinate system. The three-dimensional coordinate system has three axes respectively representing distance in the movement direction of the own vehicle, distance in the width direction of the own vehicle, and elapsed time from the current time.

Then, the collision determination apparatus determines whether there are one or more intersections between the estimated movement route of the own vehicle and the estimated movement route of the detected object to accordingly determine whether there will be a collision of the own vehicle with the detected object. This makes it possible to perform proper collision determination of the own vehicle in consideration of the elapsed time.

### SUMMARY

The inventors of the above-identified application have clarified, through careful consideration, that, although the estimated movement route matches an actual movement route if the detected object is moving straight at a uniform speed, the estimated movement route may deviate from the actual movement route of the detected object if the detected object is turning.

From this viewpoint, the present disclosure seeks to provide collision determination apparatuses and collision determination program products, each of which is capable of reducing a deviation of an estimated movement route of a detected object from an actual movement route of the detected object when the detected object is turning to accordingly improve the accuracy of determining whether there will be a collision of an own vehicle with the detected object.

An exemplary aspect of the present disclosure provides a collision determination apparatus for determining whether there will be a collision of an own vehicle with an object detected by an object detection device. The collision determination apparatus includes an own-vehicle route calculator configured to calculate, based on motion information on the own vehicle measured by at least one vehicular device installed in the own vehicle, an estimated first movement route of the own vehicle in a three-dimensional coordinate system. The three-dimensional coordinate system is defined to have a first axis representing distance in a width direction of the own vehicle, a second axis representing distance in a direction of travel of the own vehicle, and a third axis representing elapsed time from a current time. The collision determination apparatus includes an object route calculator configured to calculate, based on a position of the detected object detected by the object detection device, an estimated second movement route of the detected object in the three-dimensional coordinate system. The collision determination apparatus includes a collision determiner configured to determine whether there is an intersection between the estimated first movement route of the own vehicle and the estimated second movement route of the detected object to accordingly determine whether there will be a collision of the own vehicle with the detected object. The object route calculator is configured to, in response to determination that (i) the own vehicle is turning around a turning center point while following the detected object and (ii) the detected object is a preceding vehicle in front of the own vehicle, calculate, as the estimated second movement route of the detected object, a turning trajectory of the detected object around the turning center point of the own vehicle in the three-dimensional coordinate system.

This configuration of the collision determination apparatus according to the exemplary aspect calculates the estimated movement route of the detected object in the three-dimensional coordinate system as a curved route in response to determination that the own vehicle is turning while following the detected object. This makes it possible to reduce a deviation of the estimated movement route of the detected object from an actual movement route of the detected object, thus improving the collision determination accuracy of the own vehicle with the detected object.

### BRIEF DESCRIPTION OF THE DRAWINGS

Other aspects of the present disclosure will become apparent from the following description of embodiments with reference to the accompanying drawings in which:

FIG. 1 is a block diagram schematically representing an example of a configuration of a driving assistance apparatus according to an exemplary embodiment;

FIG. 2 is a graph schematically illustrating an example of an estimated own-vehicle route of an own vehicle and an example of an estimated object route of a target object calculated by the driving assistance apparatus in a predetermined three-dimensional coordinate system;

FIG. 3 is a flowchart schematically illustrating a driving assistance routine executed by the driving assistance apparatus;

FIG. 4 is a flowchart schematically illustrating a subroutine in step S130 of the driving assistance routine;

FIG. 5 is a table schematically Illustrating first to third set conditions and first and second reset conditions used for determination of whether the own vehicle is turning;

FIG. 6 is a plan view schematically illustrating a situation where the target object is located on a two-dimensional estimated own-vehicle route of the own vehicle;

FIG. 7A is a flowchart schematically illustrating a first determination task and a second determination task in step S132 of the subroutine;

FIG. 7B is a plan view schematically Illustrating an example of determination of whether at least part of the target object is located within a traffic lane of the own vehicle;

FIG. 8 is a graph schematically illustrating how to calculate a lateral positional parameter of the target object relative to a turning trajectory of the own vehicle;

FIG. 9 is a table schematically illustrating first and second conditions used for determination of whether the own vehicle is following the target object;

FIG. 10 is a graph schematically illustrating how to compare a future velocity vector of the own vehicle with a velocity vector of the target object;

FIG. 11 is a plan view schematically illustrating an exemplary situation where the absolute value of the angular difference between the future velocity vector of the own vehicle and the velocity vector of the target object becomes greater than or equal to an angular-difference threshold;

FIG. 12 is a plan view schematically illustrating an exemplary situation where a ground speed of a preceding vehicle as the target object is lower than a predetermined speed threshold and the preceding vehicle is located within the same traffic lane of the own vehicle;

FIG. 13 is a graph schematically illustrating an example of how to compare the two-dimensional estimated own-vehicle route of the own vehicle with a two-dimensional estimated object route of the target object in a two-dimensional coordinate system included in the three-dimensional coordinate system;

FIG. 14 is a graph schematically illustrating a comparison result between the estimated own-vehicle route of the own vehicle in the three-dimensional coordinate system and an estimated object route of the target object in the three-dimensional coordinate system assuming that motion of the target object is linear uniform motion; and

FIG. 15 is a graph schematically illustrating how to calculate the estimated object route of the target object as a turning trajectory around a turning center point of the own vehicle.

### DETAILED DESCRIPTION OF EMBODIMENT

The following describes an exemplary embodiment and its modifications of the present disclosure with reference to the accompanying drawings while assigning the same reference character to identical or equivalent parts included in the exemplary embodiment and its modifications.

First, the following describes a driving assistance apparatus 1 according to the exemplary embodiment,

A vehicle, such as a motor vehicle in which the driving assistance apparatus 1 is installed will be referred to as an own vehicle V1, and a direction, which is oriented along the longitudinal direction of the own vehicle V1 from the interior of the own vehicle V1 toward the front windshield of the own vehicle V1, will be referred to as a forward direction.

A direction, which extends along the width direction of the own vehicle V1 to the left of the own vehicle V1 when the own vehicle V1 faces in the forward direction, will be referred to as a left direction.

A direction, which extends along the width direction of the own vehicle V1 to the right of the own vehicle V1 when the own vehicle V1 faces in the forward direction, will be referred to as a right direction.

A direction in which the own vehicle V1 travels in the forward direction will be referred to as a travel direction, and a vehicle, which is located in front of the own vehicle V1 and traveling in the same lane of the own vehicle V1, will be referred to as a preceding vehicle.

### Fundamental Configuration

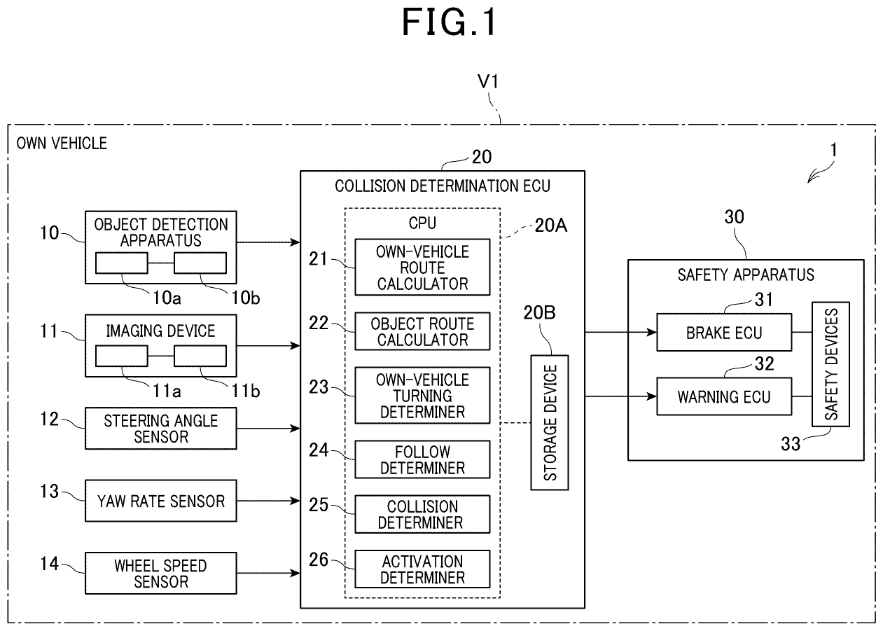

For example, the driving assistance apparatus 1 installed in the own vehicle V1 includes, as illustrated in FIG. 1, various vehicular devices, a collision determination electronic control unit (ECU) 20, and a safety apparatus 30 that includes, for example, a brake ECU 31, a warning ECU 32, and safety devices 33. The collision determination ECU 20 of the driving assistance apparatus 1 is configured to acquire, from the various vehicular devices, various information items on the own vehicle V1 and various information items on the situations surrounding the own vehicle V1, and determine, based on the acquired information items, whether there will be a collision of the own vehicle V1 with one or more other objects, such as one or more other vehicles. Then, the collision determination ECU 20 of the driving assistance apparatus 1 is configured to determine, based on the determination results, whether to activate the safety apparatus 30, and activate the safety apparatus 30 to brake the own vehicle V1 and/or issue warning information in response to determination that there will be a collision of the own vehicle V1 with the one or more other objects.

The vehicular devices include, for example, an object detection apparatus 10, an imaging device 11, a steering angle sensor 12, a yaw-rate sensor 13, and wheel speed sensors 14. Each of the vehicular devices is connected to, for example, an in-vehicle network, such as an in-vehicle local area network (LAN), and is configured to output measurement signals to the collision determination ECU 20 through the in-vehicle LAN, but may be configured to output the measurement signals directly to the collision determination ECU 20 or output the measurement signals to the collision determination ECU 20 through one or more other ECUs installed in the own vehicle V1.

The object detection device 10 is configured to externally transmit transmission waves, such as millimeter waves, and receive reflection-wave signals resulting from reflection of the transmission waves by the surface of an object, such as a vehicle other than the own vehicle V1. Then, the object detection apparatus 10 is configured to detect, based on the received reflection-wave signals, object-related information on the object, such as the position of the object, the relative speed of the object relative to the own vehicle V1, and the relative distance of the object relative to the own vehicle V1.

The object detection apparatus 10 includes, for example, a plurality of millimeter-wave radar sensors 10a for transmitting millimeter waves and receiving reflection-wave signals resulting from reflection of the transmitted millimeter waves by an object. The object detection apparatus 10 includes, for example, a plurality of radar ECUs 10b provided for the respective millimeter-wave radar sensors 10a. Each of the radar ECUs 10b is configured to calculate, based on the reflection-wave signals received by the corresponding one of the millimeter-wave radar sensors 10a, the position of the object and the relative speed of the object relative to the own vehicle V1.

For example, the millimeter-wave radar sensors 10a include at least one front millimeter-wave radar sensor mounted on the front end of the vehicle V1, and at least one rear millimeter-wave radar sensor mounted on the rear end of the own vehicle V1. Similarly, the radar ECUS 10b include at least one front radar ECU mounted on the front end of the own vehicle V1, and at least one rear radar ECU mounted on the rear end of the own vehicle V1. The at least one front radar ECU is configured to compute the reflection-wave signals from an object received by the at least one front millimeter-wave radar sensor to accordingly calculate the position of the object and the relative speed of the object relative to the own vehicle V1. Similarly, the at least one rear radar ECU is configured to compute the reflection-wave signals from an object received by the at least one rear millimeter-wave radar sensor to accordingly calculate the position of the object and the relative speed of the object relative to the own vehicle V1.

Each millimeter-wave radar sensor 10a includes, for example, one or more antennas for transmission and reception of millimeter waves, and a millimeter-wave module for generating millimeter waves.

Each radar ECU 10b is comprised of, for example, a circuit board and various electronic components, such as a central processing unit (CPU), a read-only memory (ROM), a random-access memory (RAM), and an input/output (I/O) interface, mounted on/in the circuit board. Like the radar ECUs 10b, various ECUs described later are for example each comprised of a circuit board and various electronic components, such as a CPU, a ROM, a RAM, and an I/O interface mounted on/in the circuit board.

The imaging device 11 is configured to capture images of, for example, a predetermined forward field of view of the own vehicle V1, and analyze data of the captured images using known image recognition technologies to accordingly acquire various types of traffic information on, for example, (i) lane markers on a road on which the own vehicle V1 is traveling, (ii) traffic signs on the road, (iii) and/or edges of the road, and (iv) the type of each object included in the captured images.

For example, the imaging device 11 includes at least one camera 11a configured to capture images of, for example, the predetermined forward field of view of the own vehicle V1, and an image-processing ECU 11b configured to perform analysis of the data of the images acquired by the at least one camera 11a. For example, the at least one camera 11a of the imaging device 11 is mounted to any position of the own vehicle V1 at which the at least one camera 11a enables capturing of images of the predetermined forward field of view of the own vehicle V1.

The steering angle sensor 12 is a known vehicular sensor for measuring a steering amount, such as a steering angle, of the steering wheel of the own vehicle V1 to accordingly detect the direction of motion of the own vehicle V1.

Specifically, when the steering wheel of the own vehicle V1 is operated by a driver of the own vehicle V1, the steering angle sensor 12 is for example configured to measure the driver's steering angle of the steering wheel to output a measurement signal indicative of the measured steering angle of the steering wheel. The measurement signal outputted from the steering angle sensor 12 can be used for, for example, the collision determination ECU 20 to compute the direction of travel of the own vehicle V1,

The yaw-rate sensor 13 is a known vehicular sensor for measuring the yaw rate of the own vehicle V1 around the direction of height of the own vehicle V1. Specifically, the yaw-rate sensor 13 is for example configured to measure the yaw rate of the own vehicle V1 around the direction of height of the own vehicle V1 to output a measurement signal indicative of the measured yaw rate of the own vehicle V1.

Each wheel speed sensor 14 is a known vehicular sensor for measuring rotation of the corresponding wheel of the own vehicle V1. Specifically, each of the wheel speed sensors 14 is located adjacently to the corresponding one of the four wheels of the own vehicle V1. Each wheel speed sensor 14 is configured to measure a wheel-speed parameter, such as a rotational angle, of the corresponding wheel to output a measurement signal indicative of the measured wheel-speed parameter of the corresponding wheel. The measurement signal outputted from each wheel speed sensor 14 can be used for, for example, the collision determination ECU 20 to compute the speed of the own vehicle V1.

The collision determination ECU 20 is comprised mainly of a processor, such as a CPU 20A, and a storage device, such as one or more ROMs and one or more RAMs, 20B. Function, i.e., functional units, provided by the collision determination ECU 20 can be implemented by (i) software stored in the storage device 20B and/or a non-transitory storage medium and one or more processors, such as the CPU 20A, that runs the software, (ii) only software, (ii) only one or more hardware devices, or (iv) the combination of software and one or more hardware devices.

For example, the collision determination ECU 20 includes, as such functional units, an own-vehicle route calculator 21, an object route calculator 22, an own-vehicle turning determiner 23, a follow determiner 24, a collision determiner 25, and an activation determiner 26.

The collision determination ECU 20 serves as, for example, a collision determination apparatus, and is configured to determine whether there will be a collision of the own vehicle V1 with a detected object around the own vehicle V1, such as a detected vehicle around the own vehicle V1. The collision determination ECU 20 is additionally configured to output, to, for example, the safety apparatus 30, control signals based on the result of the determination of whether there will be a collision of the own vehicle V1 with the detected object around the own vehicle V1.

For example, upon determination that there is a probability of collision of the own vehicle V1 with the detected object around the own vehicle V1, the collision determination ECU 20 is configured to determine whether a time-to-collision (TTC) between the own vehicle V1 and the detected object is less than or equal to a predetermined threshold. Then, the collision determination ECU 20 is configured to output the control signals to the safety apparatus 30 when determining that the TTC between the own vehicle V1 and the detected object is less than or equal to the predetermined threshold. The control signals instruct the brake ECU 31 and/or the warning ECU 32 to activate the safety devices 33. Activation of the safety devices 33 aims to avoid a collision of the own vehicle with the detected object.

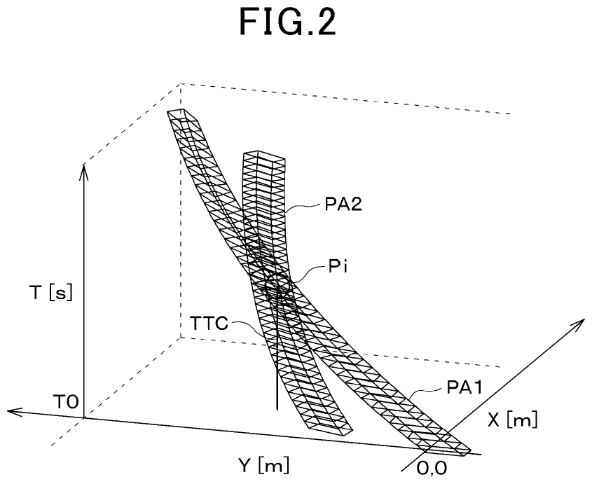

The own-vehicle route calculator 21 is configured to predict an estimated movement route of the own vehicle V1 in a predetermined three-dimensional coordinate system constituted In, for example, a storage space of the storage device 20B; the three-dimensional coordinate system is defined to have a first axis or an X axis, representing distance X meters (m) in the width direction of the own vehicle V1, a second axis or a Y axis, which is perpendicular to the first axis, representing distance Y (m) in the direction of travel of the own vehicle V1, and a third axis or a T axis, which are perpendicular to the first and second axes, representing elapsed time T seconds(s) from a current time (see FIG. 2),

Hereinafter, an estimated movement route of the own vehicle V1 in the three-dimensional coordinate system will be referred to simply as an estimated own-vehicle route PA1, and an estimated movement route of an object detected by the object detection device 10 in the three-dimensional coordinate system will be simply referred to as an estimated object route PA2. A two-dimensional system defined by the first axis and the second axis will be referred to simply as a two-dimensional system or an XY plane.

Specifically, the own-vehicle route calculator 21 is configured to predict an estimated trajectory of the own vehicle V1 drawn by the own vehicle V1 in the XY plane and an estimated curve radius if the estimated trajectory of the own vehicle V1 is curved in accordance with motion information on the own vehicle V1 measured by at least one of the vehicular devices installed in the own vehicle V1. The motion information on the own vehicle V1 may include, for example, (i) the rate of change of the steering amount, i.e., the steering angle, of the own vehicle V1 measured by the steering angle sensor 12 and (ii) the speed of the own vehicle V1 calculated based on the wheel-speed parameters measured by the respective wheel speed sensors 14.

Additionally, the own-vehicle route calculator 21 is configured to calculate a rectangular region of the own vehicle V1 on the XY plane as an own-vehicle presence region; the rectangular presence region of the own vehicle V1 includes all outer peripheral sides of the own vehicle V1 as viewed from above. For example, the own-vehicle route calculator 21 can be configured to calculate the own-vehicle presence region based on date indicative of the dimensions of the own vehicle V1 stored in the storage device 20B.

Specifically, when the current time is represented by to, the own-vehicle route calculator 21 is configured to establish the three-dimensional coordinate system such that the origin of the three-dimensional coordinate system, which will be referred to as (0, 0, T0), agrees with a reference position of the own vehicle V1 located at the current time t₀. In other words, the own-vehicle route calculator 21 is configured to establish the XY plane, i.e., the two-dimensional coordinate system or the XY coordinate system, such that the origin of the XY plane, which will be referred to as (0, 0), agrees with the reference position of the own vehicle V1 located at the current time t₀ . For example, the center of the front end of the own vehicle V1 in the width direction of the own vehicle V1 is defined as the reference position of the own vehicle V1.

The own-vehicle route calculator 21 is configured to calculate, for every predetermined time Δt within a predetermined period P from the current time t₀ to a predetermined estimation end time tₙ (n is an integer more than or equal to 2), the own-vehicle presence region at a corresponding one of positions of the expressed trajectory of the own vehicle V1 in the three-dimensional coordinate system.

For example, the own-vehicle route calculator 21 is configured to determine the direction of travel of the own-vehicle presence region corresponding to the direction of travel of the own vehicle V1 for each of the timings in accordance with, for example, the direction of a tangent line to the corresponding one of the positions of the expressed trajectory of the own vehicle V1.

Then, the own-vehicle route calculator 21 is configured to interpolate presence-region data items between the presence regions of the own vehicle V1 calculated at the respective positions of the expressed trajectory of the own vehicle V1 in the three-dimensional coordinate system to accordingly acquire the estimated own-vehicle route PA1 in the three-dimensional coordinate system. For example, when the four corners of each presence region of the own vehicle V1 will be referred to as first, second, third, and fourth corners, the own-vehicle route calculator 21 is configured to perform linear interpolation or spline interpolation between (i) the adjacent first corners, (ii) the adjacent second corners, (iii) the adjacent third corners, and (iv) the adjacent fourth corners of the calculated presence regions. Specifically, the own-vehicle route calculator 21 is configured to joint, using straight lines, between (i) the adjacent first corners, (ii) the adjacent second corners, (iii) the adjacent third corners, and (iv) the adjacent fourth corners of the calculated presence regions.

The object route calculator 22 is configured to perform one of a linear route calculation task and a curved route calculation task in accordance with a result of determination of whether the own vehicle V1 is turned.

The following describes the linear route calculation task. The curved route calculation task will be described later.

As the linear route calculation task, the object route calculator 22 is configured to calculate an estimated movement route of an object detected by the object detection device 10 in the three-dimensional coordinate system in accordance with the object-related information on the detected object detected by the object detection device 10 assuming that motion of the detected object is linear uniform motion based on the direction of the velocity vector of the detected object. The object-related Information on the detected object includes the position of the detected object, the relative speed of the detected object relative to the own vehicle V1, and the relative distance of the object relative to the own vehicle V1. Information on the velocity vector of the detected object will be described later.

Specifically, the object route calculator 22 is configured to predict an estimated trajectory, i.e., an estimated linear trajectory, of the detected object drawn by the detected object in the XY plane in accordance with change of the positions of the detected object for respective regular- or irregular-spaced object sampling timings.

Additionally, the object route calculator 22 is configured to calculate a rectangular region of the detected object on the XY plane as an object presence region for each of the object sampling timings; the rectangular presence region of the detected object includes all outer peripheral sides of the detected object as viewed from above. The size of the object presence region can be determined based on the size of the detected object calculated by the object detection device 10.

Specifically, the object route calculator 22 is configured to calculate, based on the relative speed of the detected object relative to the own vehicle V1 and the estimated trajectory of the detected object, a pass-through position on the estimated trajectory through which the detected object is estimated to pass at the predetermined end time TN of the predetermined period TP.

Then, the object route calculator 22 is configured to interpolate the object presence regions calculated for every predetermined time Δt within the predetermined period P from the current time t₀ to the estimation end time t, between the position of the detected object at the current time t₀ detected by the object detection device 10 and the calculated pass-through position on the estimated trajectory of the detected object in the three-dimensional coordinate system to accordingly acquire the estimated object route PA2 in the three-dimensional coordinate system,

The object route calculator 22 is configured to calculate the estimated object route PA2 as a curved turn trajectory upon determination that (i) the own vehicle V1 is turning, (ii) the detected object is a preceding vehicle traveling in front of the own vehicle V1, and (iii) the own vehicle V1 is controlled to follow the detected object, and otherwise calculate the estimated object route PA2 as a linear route. How the object route calculator 22 specifically calculates the estimated object route PA2 will be described in detail later.

The own-vehicle turning determiner 23 is configured to determine whether the own vehicle V1 is turning, and output a determination signal indicative of the result of the determination of whether the own vehicle V1 is turning. For example, the own-vehicle turning determiner 23 is configured to perform determination of whether the own vehicle V1 Is turning in accordance with, for example, the measurement signals outputted from one or more of the vehicular devices. How the own-vehicle turning determiner 23 specifically determines whether the own vehicle V1 is turning will be described in detail later.

The follow determiner 24 is configured to determine whether the own vehicle V1 is following a surrounding vehicle, such as a preceding vehicle, traveling in front of the own vehicle V1, and output a determination signal indicative of the result of the determination of whether the own vehicle V1 is following the preceding vehicle. For example, the follow determiner 24 is configured to determine whether there is a preceding vehicle on a traffic lane on which the own vehicle V1 is traveling. Additionally, upon determination that there is a preceding vehicle on a traffic lane on which the own vehicle V1 is traveling, the follow determiner 24 is configured to determine whether the own vehicle V1 is following the preceding vehicle. How the follow determiner 24 determines whether the own vehicle V1 is following a preceding vehicle traveling in front of the own vehicle V1 will be described in detail later.

The collision determiner 25 is configured to, for example, determine whether there will be a collision of the own vehicle V1 with the object detected by the object detection device 10. For example, the collision determiner 25 is configured to determine whether there are one or more intersections between the estimated own-vehicle route PA1 calculated by the own-vehicle route calculator 21 and the estimated object route PA2 calculated by the object route calculator 22 to accordingly determine whether there will be a collision of the own vehicle V1 with the object detected by the object detection device 10.

Specifically, the collision determiner 25 determines that there will be a collision of the own vehicle V1 with the object detected by the object detection device 10 upon determination that there are one or more intersections between the estimated own-vehicle route PA1 calculated by the own-vehicle route calculator 21 and the estimated object route PA2 calculated by the object route calculator 22. Otherwise, a collision determiner 25 determines that there will be no collision of the own vehicle V1 with the object detected by the object detection device 10 upon determination that there is no intersection between the estimated own-vehicle route PA1 calculated by the own-vehicle route calculator 21 and the estimated object route PA2 calculated by the object route calculator 22. Then, the collision determiner 25 is configured to output a determination signal indicative of the result of the determination of whether there will be a collision of the own vehicle V1 with the object detected by the object detection device 10.

The activation determiner 26 is configured to divide the relative distance of the object relative to the own vehicle V1 by the relative speed of the object relative to the own vehicle V1 to accordingly calculate a TTC between the own vehicle V1 and the detected object, and determine whether the TTC is less than or equal to the predetermined threshold. The TTC refers to time that remains before the own vehicle V1 is estimated to reach the detected object. The activation determiner 26 is configured to output, to the safety apparatus 30, the control signals for activating the safety devices 33 upon determination that the TTC is less than or equal to the predetermined threshold.

The safety apparatus 30 serves as, for example, a collision reduction apparatus for reducing the probability of collision of the own vehicle V1 with other objects. Specifically, the safety apparatus 30 includes, for example, the brake ECU 31, the warning ECU 32, and the safety devices 33. The safety devices 33 include, for example, a brake system that includes, for example, the set of a brake actuator and a brake provided for, for example, each wheel of the own vehicle V1 for braking the corresponding wheel. The safety devices 33 additionally include, for example, various warning devices, such as visible warning devices and audible warning devices, for issuing warnings. The safety devices 30 are configured to brake the own vehicle V1 and/or issue warnings.

The brake ECU 31 is configured to activate, in response to a brake activation signal and a brake control signal included in the control signals outputted from the collision determination ECU 20, each brake actuator to cause the corresponding brake to slow or stop the motion of the corresponding wheel of the own vehicle V1 while controlling the braking force applied from the brake to the corresponding wheel of the own vehicle V1. That is, the brake ECU 31 is configured to brake the own vehicle V1 while adjusting the degree of braking of the own vehicle V1 to accordingly avoid a collision of the own vehicle V1 with other objects.

More specifically, when determining that there will be a collision of the own vehicle V1 with the detected object, the collision determination ECU 25 outputs the brake activation signal and the brake control signal indicative of a requested degree of braking of the own vehicle V1 to the brake ECU 31. The brake ECU 31 activates, in response to the brake activation signal and the brake control signal, each brake actuator to cause the corresponding brake to slow or stop the motion of the corresponding wheel of the own vehicle V1 while controlling, based on the requested degree of braking of the own vehicle V1, the braking force applied from the brake to the corresponding wheel of the own vehicle V1.

The warning ECU 32 is configured to activate, in response to a warning activation signal included in the control signals outputted from the collision determination ECU 20, at least one of the warning devices to cause the at least one of the warning devices to issue visible and/or audible warnings. This assists, for example, a driver of the own vehicle V1 to perform driving operations of avoiding the own vehicle V1 from colliding with other objects.

The fundamental configuration of the driving assistance apparatus 1 according to the exemplary embodiment has been described set forth above.

The driving assistance apparatus 1 includes at least the collision determination ECU 20 essentially configured to perform a collision determination of the own vehicle V1 based on the measurement signals outputted from the vehicular devices installed in the own vehicle V1, and perform activation/deactivation control of the safety devices 30. That is, the types and/or arrangement of the vehicular devices in the own vehicle V1 can be freely changed. For example, the collision determination ECU 20 may be configured to include a single processor, such as a single determiner, configured to perform (i) the turning determination of the own vehicle V1, (ii) the follow determination of the own vehicle V1 with respect to a preceding vehicle, (iii) the collision determination of the own vehicle V1 with other objects, and (iv) the TTC threshold determination of the own vehicle V1.

### Driving Assistance Routine

Next, the following describes an example of operations carried out by the driving assistance apparatus 1.

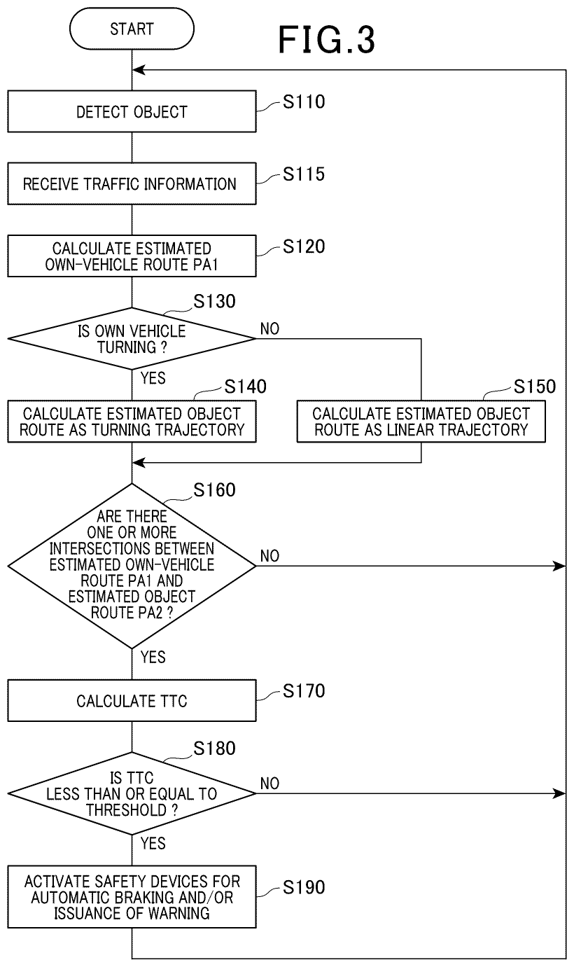

The driving assistance apparatus 1 is configured to cyclically execute a driving assistance routine, i.e., a main routine, illustrated in FIG. 3 in response to, for example, determination that a predetermined start condition, such as turn-on of the ignition switch installed in the own vehicle V1, is satisfied. In particular, the collision determination ECU 20, i.e., the CPU 20A, of the driving assistance apparatus 1 is configured to execute operations in the driving assistance routine in accordance with a driving assistance program, i.e., driving assistance program instructions, stored in the storage device 20B.

When starting the driving assistance routine, the object detection device 10 detects an object around the own vehicle V1, in particular, detects a target vehicle or an obstacle located in front of the own vehicle V1 in step S110. In step S110, the imaging device 11 can detect a target object around the own vehicle V1. When detecting a target object around the own vehicle V1, the object detection device 10 performs an object recognition task of acquiring (i) the position of the target object, (ii) the relative speed of the target object relative to the own vehicle V1, and (iii) the relative distance of the target object relative to the own vehicle V1.

Then, the object detection device 10 outputs, as the object-related information on the target object, the set of (i) the acquired position of the target object, (ii) the acquired relative speed of the target object relative to the own vehicle V1, and (iii) the acquired relative distance of the target object relative to the own vehicle V1 in step S110.

The collision determination ECU 20 receives the object-related information on the target object in step S110. In step S110, the collision determination ECU 20 can perform the object recognition task based on the measurement signals outputted from the object detection device 10 and/or the images captured by the imaging device 11.

Following the operation in step S110, the collision determination ECU 20 receives, from, for example, the imaging device 11, the various types of traffic information acquired by the imaging device 11 in step S115. The various types of traffic information include, for example, (i) lane markers on a road on which the own vehicle V1 is traveling, (ii) traffic signs on the road, (iii) edges of the road, and (iv) the type of the target object included in the captured images.

The type of the target object may show that the target object is any one of a four-wheel vehicle, a motorcycle, a pedestrian, or an obstacle, such as a fallen object on the road. The type of the target object can be detected by the object detection device 10.

Following the operation in step S115, the collision determination ECU 20 serves as, for example, the own-vehicle route calculator 21 to calculate, as described above, the estimated own-vehicle route PA1 in the three-dimensional coordinate system in accordance with, for example, (i) the rate of change of the steering amount, i.e., the steering angle, of the own vehicle V1 measured by the steering angle sensor 12 and (ii) the speed of the own vehicle V1 calculated based on the wheel-speed parameters measured by the respective wheel speed sensors 14 in step S120.

Next, the collision determination ECU 20 serves as, for example, a turning follow determiner, i.e., the own-vehicle turning determiner 23 and the follow determiner 24, to determine whether the own vehicle V1 is turning while following the target object, such as, a preceding vehicle, in accordance with, for example, (i) the steering angle of the own vehicle V1 measured by the steering angle sensor 12, (ii) the yaw rate of the own vehicle V1 measured by the yaw-rate sensor 13, and/or (iii) the speed of the own vehicle V1 calculated based on the wheel-speed parameters measured by the respective wheel speed sensors 14 in step S130.

In response to determination that the own vehicle V1 is turning while following the target object, such as, the preceding vehicle (YES in step S130), the driving assistance routine proceeds to step S140, Otherwise, in response to determination that the own vehicle V1 is not turning while following the target object or that the own vehicle V1 is turning without following the target object (NO in step S130), the driving assistance routine proceeds to step S150. How the collision determination ECU 20 determines whether the own vehicle V1 is turning while following the target object will be described in detail later.

In step S140, the collision determination ECU 20 serves as, for example, the object route calculator 22 to calculate, using a route calculation method described later, an estimated object route PA2 in the three-dimensional coordinate system as a curved route assuming that the trajectory of the target object draws a trajectory that is substantially identical to the trajectory of the turning own vehicle V1, that is, draws a curved trajectory that is substantially identical to a turning trajectory of the own vehicle V1. The operation in step S140, which calculates the estimated object route PA2 as a curved trajectory that is identical to the turning trajectory of the own vehicle V1, enables a deviation of the estimated object route PA2 from an actual movement route of the target object to be smaller as compared with a case where the object estimated movement route of the target object is calculated as a linear route. This therefore makes it possible to improve the accuracy of determining whether there are one or more intersections between the estimated own-vehicle route PA1 and the estimated object route PA2 to accordingly improve the accuracy of identifying the position of the intersection, resulting in an improvement of the collision determination accuracy of the own vehicle V1 in step S160 described later. After completion of the operation in step S140, the driving assistance routine proceeds to step S160.

In step S150, the collision determination ECU 20 serves as, for example, the object route calculator 22 to calculate, as described above, an estimated object route PA2 of the target object in the three-dimensional coordinate system as a linear trajectory assuming that motion of the target object is linear uniform motion based on the direction of the velocity vector of the target object. After completion of the operation in step S150, the driving assistance routine proceeds to step S160.

In step S160, the collision determination ECU 20 serves as, for example, the collision determiner 25 to determine whether there are one or more intersections between the estimated own-vehicle route PA1 calculated in step S120 and the estimated object route PA2 calculated in step S140 or S150 to accordingly determine whether there will be a collision of the own vehicle V1 with the target object.

In response to determination that there are one or more intersections between the estimated own-vehicle route PA1 and the estimated object route PA2 (YES in step S160), the driving assistance routine proceeds to step S170. Otherwise, in response to determination that there are no intersections between the estimated own-vehicle route PA1 and the estimated object route PA2 (NO in step S160), the driving assistance routine returns to step S110.

In step S170, the collision determination ECU 20 serves as, for example, the activation determiner 26 to identify an intersection coordinate point Pi in the three-dimensional coordinate system at which the estimated own-vehicle route PA1 intersects with the estimated object route PA2. If there are intersections between the estimated own-vehicle route PA1 and the estimated object route PA2, the collision determination ECU 20 serves as, for example, the activation determiner 26 to select one of the intersections, which has the earliest value on the T axis, and identify the selected intersection as the intersection coordinate point Pi in the three-dimensional coordinate system. Then, the collision determination ECU 20 serves as, for example, the activation determiner 26 to identify the value of the intersection coordinate point Pi on the T axis to accordingly determine the identified value of the intersection coordinate point Pi on the T axis as a TTC between the own vehicle V1 and the target object, which represents time that remains before the own vehicle V1 is estimated to reach the target object.

Following the operation in step S170, the collision determination ECU 20 serves as, for example, the activation determiner 26 to determine whether the TTC calculated in step S170 is less than or equal to the predetermined threshold in step S180. In response to determination that the TTC calculated in step S170 is less than or equal to the predetermined threshold (YES in step S180), the driving assistance routine proceeds to step S190. Otherwise, in response to determination that the TTC calculated in step S170 is more than the predetermined threshold (NO in step S180), the driving assistance routine returns to step S110.

In step S190, the collision determination ECU 20 serves as, for example, the activation determiner 26 to generate the control signals for activating the safety devices 33, and output, to at least one of the brake ECU 31 and the warning ECU 32, the generated control signals.

When receiving the brake activation signal and the brake control signal as the control signals, the brake ECU 31 activates each brake actuator to cause the corresponding brake to slow or stop the motion of the corresponding wheel of the own vehicle V1 while controlling the braking force applied from the brake to the corresponding wheel of the own vehicle V1. When receiving the warning activation signal as the control signals, the warning ECU 32 activates at least one of the warning devices to cause the at least one of the warning devices to issue visible and/or audible warnings.

This enables automatic braking of the own vehicle V1 and/or issuance of visible and/or audible warnings without driver's operations, making it possible to alert the driver and/or reduce the probability of collision of the own vehicle V1 with the target object. After completion of the operation in step S190, the driving assistance routine returns to step S110.

When returning to the operation in step S110, the driving assistance apparatus 1 iterates the driving assistance routine from the operation in step S110 until a predetermined termination condition, such as turnoff of the ignition switch, is satisfied.

The exemplary assistance operations of the driving assistance apparatus 1 have been described.

That is, the driving assistance apparatus 1 is configured to calculate, in step S140, an estimated object route PA2 of a preceding vehicle detected as a target object in the three-dimensional coordinate system as a curved route in response to determination that the own vehicle V1 is turning while following the preceding vehicle. This makes it possible to reduce a deviation of the estimated object route PA2 from an actual movement route of the preceding vehicle, thus improving the collision determination accuracy of the own vehicle V1.

### Turning and Follow Determination

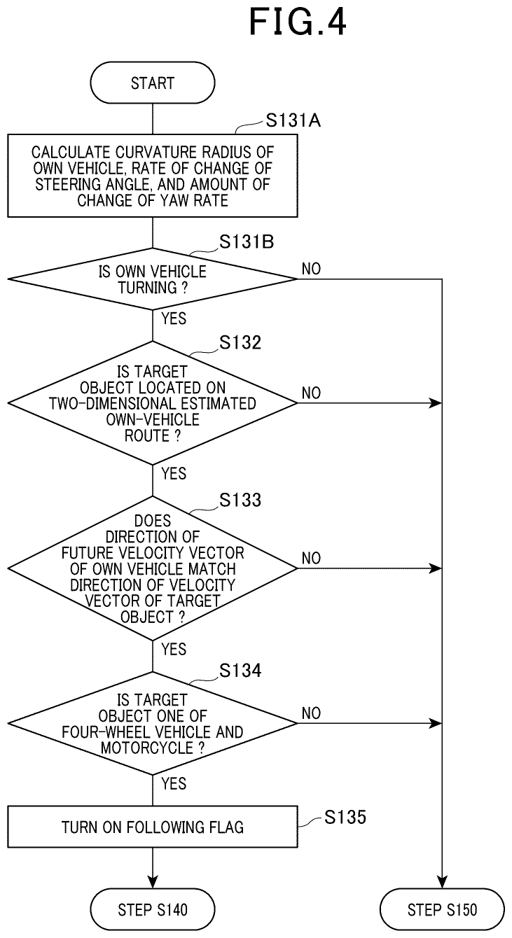

The following describes in detail the operation of determining whether the own vehicle V1 is turning while following a preceding vehicle in step S130 as a turning following determination subroutine, which will also be referred to simply as a subroutine, illustrated in FIG. 4.

For example, when the operation in step S120 is completed, the collision determination ECU 20 determines that a predetermined start condition of the subroutine illustrated in FIG. 4, and starts the subroutine illustrated in FIG. 4.

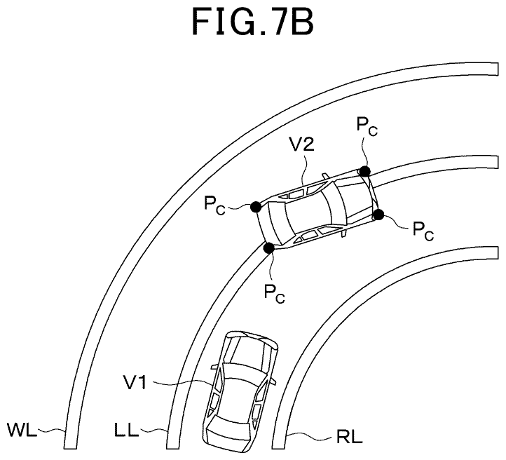

When starting the subroutine illustrated in FIG. 4, the collision determination ECU 20 estimates, based on the steering angle of the own vehicle V1 measured by the steering angle sensor 12, a virtual travel trajectory of the own vehicle V1 based on the steering angle of the own vehicle V1, and calculates a radius of curvature, which has the unit of meters (m), of the virtual travel trajectory of the own vehicle V1 in step S131A. The radius of curvature of the virtual travel trajectory of the own vehicle V1 will be referred to as a curvature radius R of the own vehicle V1 (see, for example, FIG. 8).

The curvature radius R of the own vehicle V1 is defined as a positive value when the own vehicle V1 takes a curve in a clockwise direction, and as a negative value when the own vehicle V1 takes a curve in a counterclockwise direction. Additionally, the curvature radius R of the own vehicle V1 is defined as an indefinite value when the own vehicle V1 is traveling straight.

The curvature radius R of the own vehicle Vi can also be calculated based on the estimated own-vehicle route PA1.

Additionally, the collision determination ECU 20 calculates, based on the steering angle of the own vehicle V1 measured by the steering angle sensor 12, the rate of change of the steering angle in step S131A. The rate of change of the steering angle is defined as a positive value when the own vehicle V1 is turning clockwise, and as a negative value when the own vehicle V1 is turning counterclockwise.

The collision determination ECU 20 calculates, based on the yaw rate of the own vehicle V1 measured by the yaw-rate sensor 13, the amount of change of the yaw rate in step S131A. The amount of change of the yaw rate is defined as a positive value when the own vehicle V1 is turning clockwise, and as a negative value when the own vehicle V1 is turning counterclockwise.

Then, the collision determination ECU 20 determines whether predetermined first to third set conditions based on (i) the curvature radius R of the own vehicle V1, (ii) the rate of change of the steering angle, and (iii) the amount of change of the yaw rate are satisfied using predetermined first to third start thresholds to accordingly determine whether the own vehicle V1 is turning in step S131B.

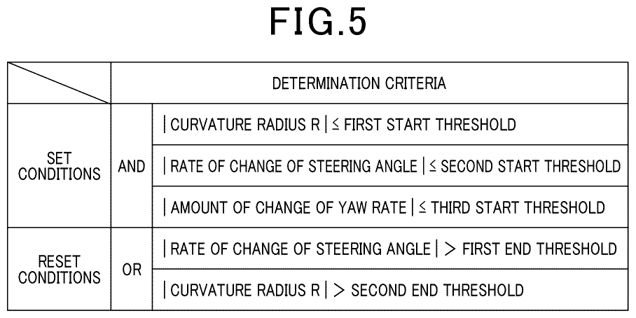

The first to third set conditions are illustrated as a table format in FIG. 5.

The first set condition is that the absolute value of the curvature radius R of the own vehicle V1 is smaller than or equal to the first start threshold.

The second set condition is that the absolute value of the rate of change of the steering angle is smaller than or equal to the second start threshold.

The third set condition is that the amount of change of the yaw rate is smaller than or equal to the third start threshold.

The term “AND” in FIG. 5 means that, when all the first to third set conditions are satisfied, the determination of whether the own vehicle V1 is turning in step S131B is affirmative (YES in step S131B).

For example, each of the first to third set thresholds is variably determined depending on the speed of the own vehicle V1 such that, the lower the speed of the own vehicle V1, the smaller each of the first to third set thresholds,

A typical situation where the collision determination ECU 20 determines that all the first to third set conditions are satisfied so that the collision determination ECU 20 determines that the own vehicle V1 is turning is that the own vehicle V1 is turning at a substantially constant steering angle to draw a curve with a substantially constant radius of curvature. Accordingly, if the own vehicle V1 is traveling straight, the collision determination ECU 20 determines that the first condition is not satisfied so that the collision determination ECU 20 determines that the own vehicle V1 is not turning. Additionally, if the own vehicle V1 is swerving or traveling on a road having varying curves, the collision determination ECU 20 determines that at least one of the second set condition and the third set conditions is not satisfied, so that the collision determination ECU 20 determines that the own vehicle V1 is not turning.

Otherwise, in response to determination that at least one of the first to third set conditions is unsatisfied so that it is determined that the own vehicle V1 is not turning (NO in step S131B), the determination in step S130 of the main routine is negative, so that the driving assistance routine proceeds to step S150 of the main routine.

Additionally, in step S131B, the collision determination ECU 20 determines that the own vehicle V1 is not turning (NO in step S131B) upon determination that at least one of a predetermined first reset condition and a predetermined second reset condition is satisfied based on (i) the curvature radius R of the own vehicle V1 and (ii) the rate of change of the steering angle.

The first and second reset conditions are illustrated as the table format in FIG. 5.

The first reset condition is that the absolute value of the rate of change of the steering angle is greater than a first end threshold.

The second reset condition is that the absolute value of the curvature radius R of the own vehicle V1 is greater than a second end threshold,

The term “OR” in FIG. 5 means that, when at least one of the first and second reset conditions is satisfied, the determination of whether the own vehicle V1 is turning in step S131B is negative. The first end threshold for the rate of change of the steering angle can be set to be equal to or different from the second start threshold for the rate of change of the steering angle. The second end threshold for the curvature radius R of the own vehicle V1 can be set to be equal to or different from the first start threshold for the curvature radius R of the own vehicle V1.

Additionally, after determining that all the first to third set conditions are satisfied to accordingly determine that the own vehicle V1 is turning (YES in step S131B), the collision determination ECU 20 is configured to iterate the determination in step S131B every predetermined cycle, and maintain the affirmative determination that the own vehicle V1 is turning until at least one of the first reset condition and the second reset condition is satisfied,

Following or in parallel to the operations in steps S131A and 131B, the collision determination ECU 20 serves as, for example, the follow determiner 24 to perform the following operations in steps S132 to 134. The operations in steps S132 to 134 enable the collision determination ECU 20 to determine whether predetermined plural follow requirements are satisfied.

Note that the collision determination ECU 20 can be configured to project, for example in step S120, the estimated own-vehicle route PA1 on the XY plane or the XY coordinate system as a two-dimensional estimated own-vehicle route PA11. Similarly, the collision determination ECU 20 can be configured to project, for example in step S140 or S150, the estimated object route PA2 on the XY coordinate system or the XY coordinate system as a two-dimensional estimated object route PA21.

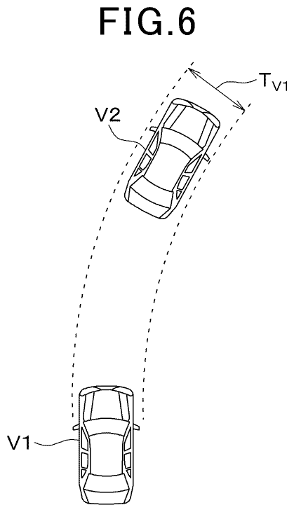

Specifically, the collision determination ECU 20 serves as, for example, the follow determiner 24 to determine whether the target object is located on the two-dimensional estimated own-vehicle route PA11 in step S132 (see FIG. 6). In FIG. 6, a preceding vehicle V2 is Illustrated as the target object, and the paired outer edges of the two-dimensional estimated own-vehicle route PA11 are respectively illustrated as dashed lines.

In response to determination that the target object is located on the two-dimensional estimated own-vehicle route PA11 (YES in step S132), the subroutine proceeds to step S133. Otherwise, in response to determination that the target object is not located on the two-dimensional estimated own-vehicle route PA11 (NO in step S132), the determination in step S130 of the main routine is negative, so that the driving assistance routine proceeds to step S150 of the main routine.

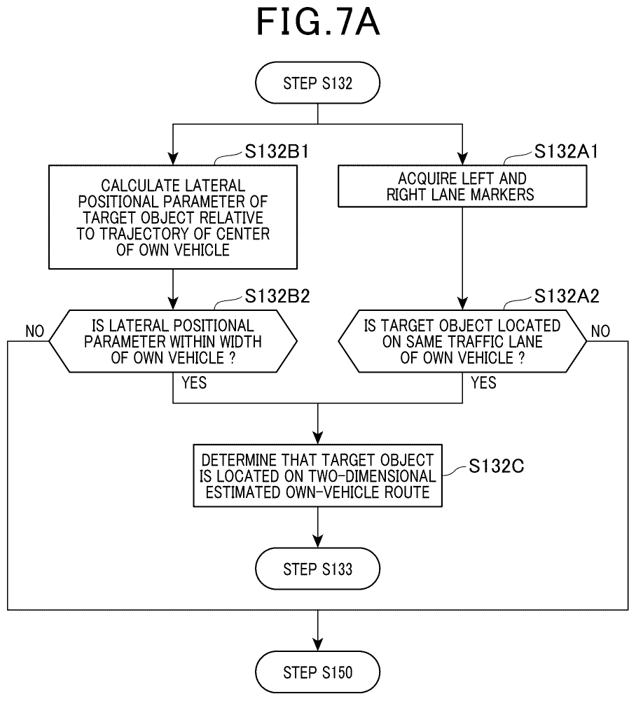

The collision determination ECU 20 serves as, for example, the follow determiner 24 to perform at least one of a first determination task and a second determination task in step S132 (see FIG. 7A),

Specifically, when starting the first determination task, the collision determination ECU 20 serves as, for example, the follow determiner 24 to acquire a left-side lane marker LL and a right-side lane marker RL of a traffic lane TL of a road RD on which the own vehicle V1 is traveling from the imaging device 11 in step S132A1. Note that markers WL painted on the road RD, which include the left-and right-side lane markers LL and RL, are recognized by, for example, the image-processing ECU 11b that uses known image recognition technologies of one or more images captured by the at least one camera 11a. Recognition of the left-and right-side lane markers LL and RL can be carried out by the collision determination ECU 20 based on one or more images captured by the at least one camera 11a.

Then, the collision determination ECU 20 serves as, for example, the follow determiner 24 to determine whether the target object detected in step S110 is located on the same traffic lane TL of the own vehicle V1 surrounded by the recognized left-and right-side lane markers LL and RL in step S132A2.

Specifically, the follow determiner 24 recognizes, as illustrated in FIG. 7B, the coordinates of each of the four corner points PC of the rectangular presence region of a preceding vehicle V2 detected as the target object in the XY coordinate system in step S110, and determines whether the coordinates of at least one of the four corner points PC of the rectangular presence region of the preceding vehicle V2 in the XY coordinate system are located within the traffic lane TL of the own vehicle V1 in the XY coordinate system in step S132A2.

In response to determination that the coordinates of at least one of the four corner points PC of the rectangular presence region of the preceding vehicle V2 in the XY coordinate system are located within the traffic lane TL of the own vehicle V1 in the XY coordinate system (YES in step S132A2), the follow determiner 24 outputs an affirmative determination signal as the result of the first determination task.

Otherwise, in response to determination that the coordinates of all the four corner points PC of the rectangular presence region of the preceding vehicle V2 in the XY coordinate system are located outside the coordinates of the traffic lane TL of the own vehicle V1 in the XY coordinate system (NO in step S132A2), the determination in step S130 of the main routine is negative, so that the driving assistance routine proceeds to step S150 of the main routine. If the target object detected in step S110 is not a preceding vehicle or a vehicle other than the own vehicle V1, the first determination task can be similarly carried out.

Additionally, when starting the second determination task, the collision determination ECU 20 serves as, for example, the follow determiner 24 to calculate a lateral positional parameter xR of a curvature-based corrected position of the target object relative to the two-dimensional estimated own-vehicle route PA11 in the XY coordinate system, and determine, based on the lateral positional parameter xR of the curvature-based corrected position of the target object, whether the target object is located on the two-dimensional estimated own-vehicle route PA11. The second determination task will also be referred to as a lateral positional parameter determination task.

Specifically, the collision determination ECU 20 serves as, for example, the follow determiner 24 to determine a trajectory CT of the center of the own vehicle V1 along the two-dimensional estimated own-vehicle route PA11, and corrects the estimated position of any selected point of the target object in the XY coordinate system based on the curvature radius R of the own vehicle V1 to accordingly calculate the curvature-corrected position of the selected point of the target object in the XY coordinate system.

Then, the collision determination ECU 20 serves as, for example, the follow determiner 24 to calculate the lateral positional parameter xR of the curvature-based corrected position of the selected point of the target object with respect to the trajectory CT of the center of the own vehicle V1 in step S132B1.

For example, let us assume that the point on the X axis of the XY coordinate system, which is located by the curvature radius R of the own vehicle V1 away from the reference position of the own vehicle V1, is defined as a turning center point P1, the estimated position of, for example the center, of the target object in the XY coordinate system is defined as a point P2, and the curvature-based corrected position of the estimated position of the selected point of the target object in the XY coordinate system will be referred to as a P_{RC}.

The above assumption enables the lateral positional parameter xR of the curvature-based corrected position P_{RC} of the estimated position of the selected point of the target object to be represented as the distance between the trajectory CT of the center of the own vehicle V1 and the curvature-based corrected position P_{RC} on a virtual linear line connecting between the turning center point P1 and the point P2.

For example, the lateral positional parameter xR of the curvature-based corrected position PRc can be calculated in accordance with the following formula (1):

$$xR = \vert R \vert - sign ( R ) \cdot \sqrt{{( y + z )}^{2} + {( \vert R \vert - sign ( R ) )}^{2}} \qquad ( 1 )$$

where:
(1) Reference character x represents the distance (m) of, for example, the center of the own vehicle V1 from the point P2 of the target object in the XY coordinate system;
(2) Reference character y represents the distance (m) of the mount position of the object detection device 10 in the travel direction of the own vehicle V1 from the point P2 of the target object in the XY coordinate system;
(3) Reference character z represents the distance (m) of the rear-wheel axis of the own vehicle V1 from the mount position of the object detection device 10 in the travel direction of the own vehicle V1 in the XY coordinate system; and
(4) Reference character sign (R) represents a sign function that becomes +1 when the curvature radius R of the own vehicle V1 is a positive value, and −1 when the curvature radius R of the own vehicle V1 is a negative value.

As described above, the curvature radius R of the own vehicle V1 is defined as a positive value when the own vehicle V1 takes a curve in the clockwise direction, and as a negative value when the own vehicle V1 takes a curve in the counterclockwise direction. Alternatively, the curvature radius R of the own vehicle Vi may be defined as a negative value when the own vehicle V1 takes a curve in the clockwise direction, and as a positive value when the own vehicle V1 takes a curve in the counterclockwise direction. The second term of the right side of the formula (1) represents the distance, which will be referred to as RE, between the turning center point P1 and the point P2.

When calculating the lateral positional parameter xR of the curvature-based corrected position PRc of the estimated position of the selected point of the target object in step S132B1, the collision determination ECU 20 serves as, for example, the follow determiner 24 to determine whether the calculated lateral positional parameter xR lies within the width of the own vehicle V1 in step S132B2.

In response to determination that the calculated relative lateral positional parameter xR lies within the width of the own vehicle V1 (YES in step S132B2), the collision determination ECU 20 serves as, for example, the follow determiner 24 to output an affirmative determination signal as the result of the second determination task. Otherwise, in response to determination that the calculated relative lateral positional parameter xR lies outside the width of the own vehicle V1 (NO in step S132B2), the determination in step S130 of the main routine is negative, so that the driving assistance routine proceeds to step S150 of the main routine.

Then, the collision determination ECU 20 serves as, for example, the follow determiner 24 to determine, in step S132C, that the target object is located on the two-dimensional estimated own-vehicle route PA11 in response to determination that the affirmative determination signal is outputted as at least one of the determination result in step S132A2 and the determination result in step S132B2, resulting in the affirmative determination in step S132. In particular, the follow determiner 24 may determine, in step S132C, that the target object is located on the two-dimensional estimated own-vehicle route PA11 in response to determination that both the affirmative determination signals are outputted as both the determination result in step S132A2 and the determination result in step S132B2.

Following the affirmative determination in step S132C, i.e., the affirmative determination in step S132, the collision determination ECU 20 serves as, for example, the follow determiner 24 to calculate (i) the direction of a future velocity vector V_{A1} of the own vehicle V1 in the XY coordinate system and (ii) the direction of a velocity vector V_{B} of the target object in the XY coordinate system, and determine whether the direction of the future velocity vector V_{A1} of the own vehicle V1 matches the direction of the velocity vector V_{B} of the target object in step S133.

For example, the follow determiner 24 is configured to calculate, using one of known methods, the direction of the velocity vector V_{B} of the target object in accordance with the measurement signals of the target object outputted from the object detection device 10. How the follow determiner 24 calculates the direction of the future velocity vector V_{A1} of the own vehicle V1 will be described in detail later.

In response to determination that the direction of the future velocity vector V_{A1} of the own vehicle V1 matches the direction of the velocity vector Vs of the target object (YES in step S133), the subroutine proceeds to step S134. Otherwise, in response to determination that the direction of the future velocity vector V_{A1} of the own vehicle V1 does not match the direction of the velocity vector V_{B} of the target object (NO in step S133), the determination in step S130 of the main routine is negative, so that the driving assistance routine proceeds to step S150 of the main routine.

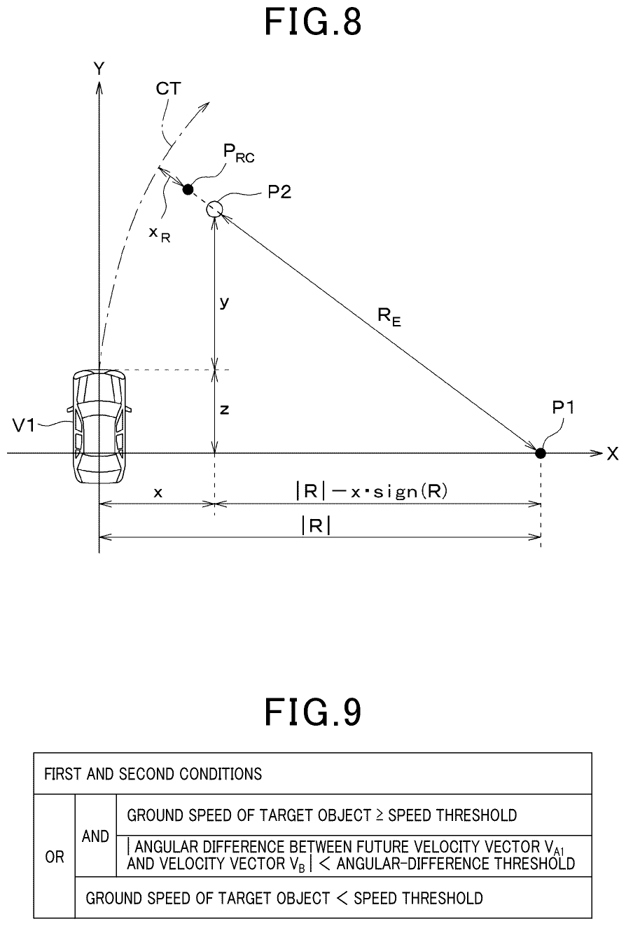

Specifically, the collision determination ECU 20 serves as, for example, the follow determiner 24 to determine whether at least one of a first condition and a second condition illustrated in, for example, FIG. 9 is satisfied in step S133.

The first condition is, for example, that (i) a ground speed of the target object is higher than or equal to a predetermined speed threshold and (ii) an absolute value of an angular difference between the future velocity vector V_{A1} of the own vehicle V1 and the velocity vector V_{B} of the target object is smaller than an angular-difference threshold. The ground speed of the target object can be calculated based on, for example, (i) the speed of the own vehicle V1 calculated based on the wheel-speed parameters measured by the respective wheel speed sensors 14 and (ii) the relative speed of the target object relative to the own vehicle V1 measured by the object detection apparatus 10.

The second condition is, for example, that the ground speed of the target object is lower than the predetermined speed threshold.

The determination of whether at least one of the first condition and the second condition is satisfied will also be referred to as a direction determination.

The following describes the absolute value of the angular difference, which has the unit of degrees (deg), between the future velocity vector V_{A1} of the own vehicle V1 and the velocity vector V_{B} of the target object,

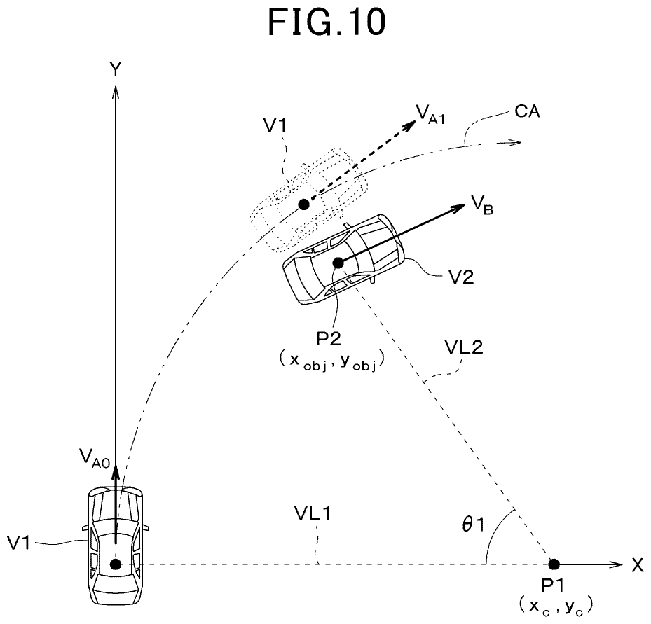

For example, FIG. 10 illustrates (i) the own vehicle V1 located at the current location, (ii) a preceding vehicle V2 located as the target object, (iii) a current velocity vector of the own vehicle V1 in the XY coordinate system as V_{A0}, (iv) the future vector velocity V_{A1} of the own vehicle V1, and the current velocity vector V_{B} of the preceding vehicle V2. The future velocity vector V_{A1} of the own vehicle V1 represents the velocity vector of the own vehicle V1 if the own vehicle V1 will be located adjacent to the current position of the preceding vehicle V2. The current velocity vector of the preceding vehicle V2 is illustrated as V_{B}.

The future voltage vector V_{A1} can be calculated by correcting the current velocity vector V₀ of the own vehicle V1.

In FIG. 10, the preceding vehicle V2 is illustrated as a four-wheel vehicle, but a two-wheel vehicle, such as a motorcycle, can be used as the preceding vehicle,

The following describes an example of how the follow determiner 24 calculates the future velocity vector V_{A1} of the own vehicle V1. For example, let us assume that, as illustrated in FIG. 10, each of the own vehicle V1 is turning around the turning center point P1, which is located on the X axis of the XY coordinate system by the curvature radius R of the own vehicle V1 away from the reference position of the own vehicle V1. Additionally, let us assume that an angle formed by (i) a first virtual line VL1 that connects between the center of the own vehicle V1 and the turning center point P1 in the XY coordinate system and (ii) a second virtual line VL2 that connects between the turning center point P1 and the point P2 located at the center of the preceding vehicle V2 is defined as an angle θ1.

In this assumption, turning the first virtual line VL1 around the turning center point P1 by the angle θ1 enables a circular arc CA to be formed as the trajectory of the edge of the first virtual line VL1. The direction of a tangent line at an end point E of the circular arc CA corresponds to the direction of the future velocity vector V_{A1}.

That is, the future velocity vector V_{A1} is a velocity vector of the own vehicle V1 when the own vehicle V1 is circulated to move on the second virtual line VL2 or its extension line. In other words, correcting the current velocity vector V_{A0} to curve the current velocity vector V_{A0} by the angle θ1 enables the future velocity vector V_{A1} to be calculated.

In FIG. 10, the future location of the own vehicle V1 on the extension line of the second virtual line VL2 after turning of the own vehicle V1 by the angle θ1 is illustrated by dashed lines, and the circular arc CA acquired as the trajectory of the edge of the first virtual line VL1 is illustrated by dash-double-dot line.

Let us assume that the coordinates of the turning center point P1 in the XY coordinate system are shown as (x_{c}, y_{c}), and the coordinates of the point P2 in the XY coordinate system are shown as (x_{obj}, y_{obj}). Additionally, the sign of each of the coordinates (x_{c}, y_{c}) and the coordinates (x_{obj}, y_{obj}) is positive when the direction from the own vehicle V1 to the preceding vehicle V2 along the circular arc CA is the counterclockwise direction, and is negative when the direction from the own vehicle V1 to the preceding vehicle V2 along the circular arc CA is the clockwise direction

In this assumption, the angle θ1 can be calculated in accordance with the following formula (2) when the curvature radius R of the own vehicle V1 is negative or the following formula (3) when the curvature radius R of the own vehicle V1 is more than or equal to 0.

$$θ1 = {tan}^{- 1} \frac{{y}_{obj} - {y}_{c}}{{x}_{obj} - {x}_{c}} \qquad ( 2 )$$

$$θ1 = {tan}^{- 1} \frac{- ( {y}_{obj} - {y}_{c} )}{- ( {x}_{obj} - {x}_{c} )} \qquad ( 3 )$$

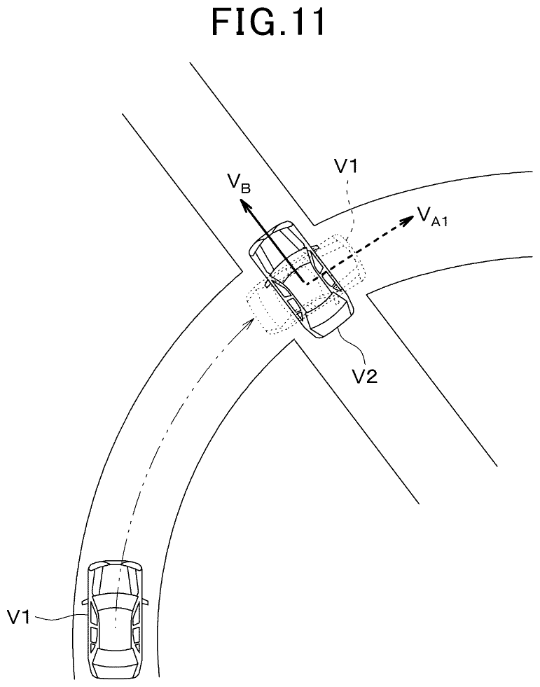

A case where the absolute value of the angular difference between the future velocity vector V_{A1} and the velocity vector V_{B} becomes greater than or equal to the angular-difference threshold may occur in a situation where the preceding vehicle V2 is temporarily passing through the two-dimensional estimated own-vehicle route PA11 while traveling along a road different from the road on which the own vehicle V1 is traveling (see FIG. 11). Otherwise, a case where the absolute value of the angular difference between the future velocity vector V_{A1} and the velocity vector V_{B} becomes smaller than the angular-difference threshold may occur in a situation where the own vehicle V1 and the preceding vehicle V2 are traveling toward the same direction. The speed threshold for the ground speed of the target object in each of the first and second conditions may be set to, for example, a very low speed. This aims to pass over the velocity vector of the preceding vehicle V2 when the ground speed of the preceding vehicle V2 is lower than the speed threshold due to error of the velocity vector of the preceding vehicle V2.

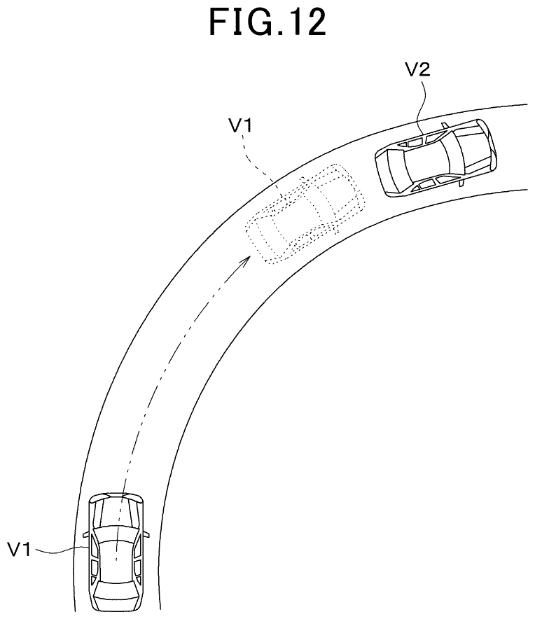

In particular, in step S133, when determining that the second condition is satisfied, i.e., the ground speed of the target object is lower than the speed threshold, the collision determination ECU 20 serves as, for example, the follow determiner 24 to determine that the target vehicle is a stationary target object that the own vehicle V1 follows and therefore the direction of the velocity vector V_{A1} matches the direction of the velocity vector V_{B}, because the target object is determined to be located on the two-dimensional estimated own-vehicle route PA11 in step S132. A typical situation where the second condition is satisfied in the direction determination is that, as illustrated in FIG. 12, the own vehicle V1 is likely to reach the preceding vehicle V2.

In step S134, the collision determination ECU 20 serves as, for example, the follow determiner 24 to determine whether the target object detected in step S110 is one of a vehicle or a bicycle using, for example, the object recognition task of the object detection device 10 and/or image recognition of the one or more images captured by the camera 11a. Then, in response to determination that the target object detected in step S110 is a four-wheel vehicle or a motorcycle (YES in step S134), the subroutine proceeds to step S135. Otherwise, in response to determination that the target object detected in step S110 is neither a four-wheel vehicle nor motorcycle (NO in step S134), the determination in step S130 of the main routine is negative, so that the driving assistance routine proceeds to step S150 of the main routine.

In step S135, the collision determination ECU 20 serves as, for example, the follow determiner 24 to set a turning following flag to be on; the turn-on of the follow flag represents that the own vehicle V1 is turning while following the four-wheel vehicle or the motorcycle as the target object. That is, the turn-on of the turning following flag determines that the own vehicle V1 is turning while following the target object (YES in step S130). This results in the determination in step S130 of the main routine is affirmative, so that the driving assistance routine proceeds to step S140 of the main routine.

The on state of the turning following flag is reset to be off when the subroutine illustrated in FIG. 4 in the next cycle of the driving assistance routine illustrated in FIG. 3 is started.

The fundamental operations of the turning following determination subroutine in step S130 have been described. The execution order of the determinations in steps S131 to S134 can be freely changed.

Next, the following describes in detail how the collision determination ECU 20 serves as, for example, the object route calculator 22 to calculate the estimated object route PA2 in response to determination that the own vehicle V1 is turning while following the target object in step S140.

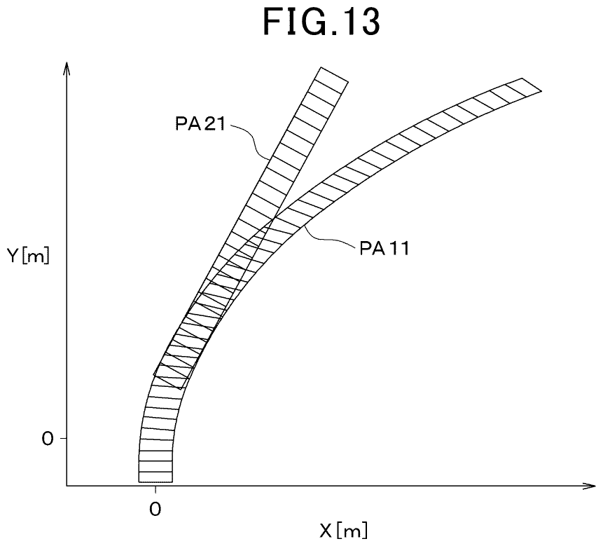

As described above, projecting the estimated own-vehicle route PA1 on the XY coordinate system or the XY coordinate system enables the two-dimensional estimated own-vehicle route PA11 to be calculated on the XY coordinate system or the XY coordinate system (see FIG. 13). Similarly, projecting the estimated object route PA2 on the XY coordinate system or the XY coordinate system enables the two-dimensional estimated object route PA21 to be calculated on the XY coordinate system or the XY coordinate system (see FIG. 13).

It is possible to determine whether there are one or more intersections between the two-dimensional estimated own-vehicle route PA11 and the two-dimensional estimated object route PA21 to accordingly determine whether there will be a collision of the own vehicle V1 with the target object.

In particular, to further improve the accuracy of determining whether there will be a collision of the own vehicle V1 with the target object, the collision determination ECU 20 is configured to calculate the estimated own-vehicle route PA1 and the estimated object route PA2 in the three-dimensional coordinate system defined to have the X axis representing distance X in the width direction of the own vehicle V1, the Y axis representing distance Y in the direction of travel of the own vehicle V1, and the T axis representing elapsed time T from the current time (see FIG. 2).

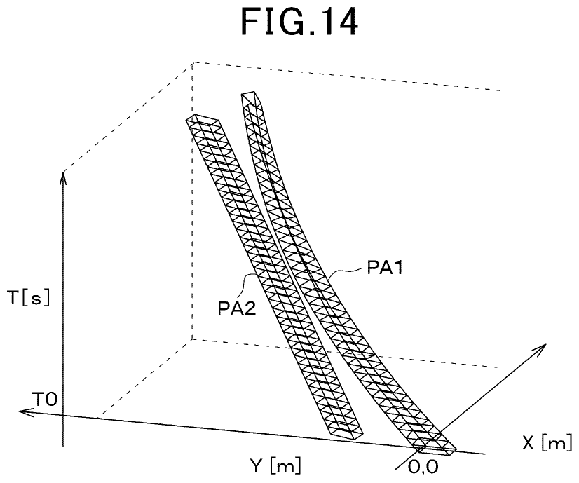

For example, there is a case where, as illustrated in FIG. 13, the two-dimensional estimated own-vehicle route PA11 seems to Intersect with the two-dimensional estimated object route PA21 illustrated in FIG. 13, but, as illustrated in FIG. 14, it is clear that the estimated own-vehicle route PA1 expressed in the three-dimensional coordinate system does not intersect with the estimated object route PA2 expressed in the three-dimensional coordinate system.

The Inventors of the above-identified application have clarified, through careful consideration, that because the conventional technology does not consider whether the target object is turning when calculating an estimated movement route of the target object, the conventional estimated object route, which will be referred to as a PA2A, may deviate from the actual movement route of the target object if the target object is turning. The conventional technology may therefore result in a poor accuracy of determining whether there will be a collision of the own vehicle V1 with the target object.

Specifically, the conventional technology predicts such an estimated object route PA2A based on (i) the current position of the target object located at the current time t₀ acquired from, for example, the object detection apparatus 10 and (ii) the ground speed of the target object. The ground speed of the target object can be calculated based on the wheel-speed parameters measured by the respective wheel speed sensors 14 and the relative speed of the target object relative to the own vehicle V1 measured by the object detection apparatus 10.

The estimated object route PA2A predicted based on the current position of the target object and the ground speed of the target object has a linear trajectory illustrated in, for example, FIG. 14. For this reason, if motion of the target object is linear uniform motion, the estimated object route P2A2 substantially matches an actual movement route of the target object. However, if the target object is turning, the estimated object route P2A2 may deviate from the actual movement route of the target object. Additionally, it may be difficult to calculate a turning trajectory of the target object based on the current position of the target object and the ground speed of the target object if the target object is turning,

From this viewpoint, in response to determination that the own vehicle V1 is turning while following the target object, such as, a preceding vehicle V2 (YES in step S130), the collision determination ECU 20 serves as, for example, the object route calculator 22 to calculate the estimated object route PA2 assuming that the target object, such as the preceding vehicle V2, is traveling in a curved trajectory around the turning center point P1 of the own vehicle V1 in step S140.

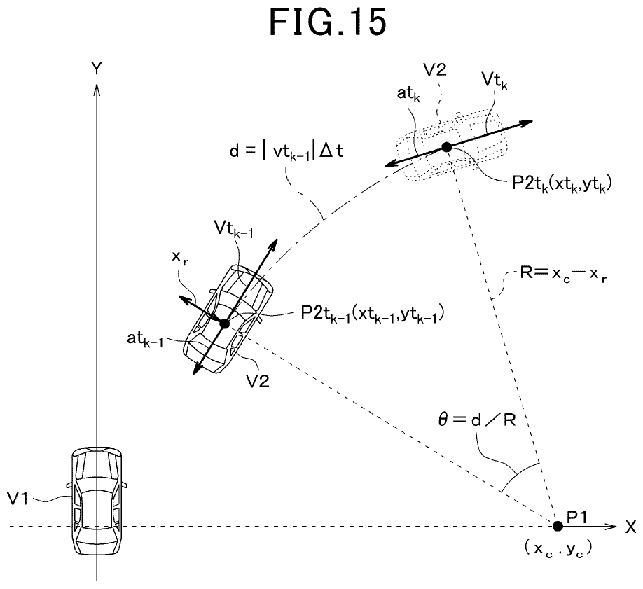

Specifically, the collision determination ECU 20 serves as, for example, the object route calculator 22 to calculate, as illustrated in FIG. 15, the estimated object route PA2 assuming that movement of the preceding vehicle V2, which is an example of target object, draws a turning trajectory around the turning center point P1 of the own vehicle V1 in step S140.

The collision determination ECU 20 serves as, for example, the object route calculator 22 to calculate, for every predetermined time Δt, the object presence region within the predetermined period P from the current time t₀ to the estimation end time tₙ.

For example, in FIG. 15, let us assume that
(I) The object presence region of the preceding vehicle V2 to be predicted at a next calculation time, i.e., a next prediction time, tₖ (k=1, 2, . . . , or n) is illustrated by dashed lines
(II) The object presence region of the preceding vehicle V2 predicted at the immediately previous prediction time tₖ₋₁ is illustrated by solid lines

Each of the prediction times tₖ₋₁ and tₖ represents a future time later than the current time t₀ and later than a time at which the preceding vehicle V2 is detected as the target object.

Additionally, let us assume that
(I) The coordinates of the center of the preceding vehicle V2 located at the time tₖ₋₁ are represented as (xtₖ₋₁, ytₖ₋₁) in the XY coordinate system
(II) The position of the center of the preceding vehicle V2 located at the time tₓ₋₁ is represented as a P2tₖ₋₁
(III) The coordinates of the center of the preceding vehicle V2 located at the time tₖ are represented as (xtₖ,ytₖ) in the XY coordinate system
(IV) The position of the center of the preceding vehicle V2 located at the time tₖ is represented as a P2tₖ
(V) The ground speed and the acceleration of the preceding vehicle V2 at the time tₖ₋₁ are respectively represented as vtₖ₋₁, atₖ₋₁
(VI) The ground speed and the acceleration of the preceding vehicle V2 at the time tₖ are respectively represented as vtₖ, atₖ

In FIG. 15, the vector of each of the ground speed vtₖ₋₁, the ground speed vtₖ, the acceleration atₖ₋₁, and the acceleration atₖ is illustrated as a corresponding arrow.

Moreover, let us assume that the angle formed by (i) a virtual line connecting between the point P1 and the point P2tₖ₋₁ and (ii) a virtual line connecting between the point P1 and the point P2tₖ is represented as θ, and the radius of curvature of a curve drawn by the preceding vehicle V2 is represented as R. Let us assume that the lateral positional parameter of the preceding vehicle V2 at the time tₖ₋₁ is represented as xᵣ, and the distance from the point P2tₖ₋₁ and the point P2tₖ for the time Δt, i.e., the movement distance of the preceding vehicle V2 for the time Δt, is represented as d. The movement distance d of the preceding vehicle V2 can be represented as the following formula d=|vtₖ₋₁|Δt, and the radius of curvature R of the curve drawn by the preceding vehicle V2 can be represented as the following formula R=x_{c}-xᵣ where x_{c} represents the coordinate of the point P1 in the X axis of the XY coordinate system.

This enables the angle θ, which represents a turning angle of the preceding vehicle V2 for the time Δt to be represented by the following formula (4).

$$θ = d / R = \vert {vt}_{k - 1} \vert Δ t / ( {x}_{c} - {x}_{r} ) \qquad ( 4 )$$

Assuming that the clockwise direction of the angle θ is the positive direction, and the anticlockwise direction of the angle θ is the negative direction, the coordinates (xtₖ,ytₖ) of the point P2tₖ in the XY coordinate system can be calculated in accordance with the following formula (5):

$$[ \begin{matrix}{xt}_{k} \\ {yt}_{k}\end{matrix} ] = [ \begin{matrix}cos θ & - sin θ \\ sin θ & cos θ\end{matrix} ] [ \begin{matrix}{xt}_{k - 1} \\ {yt}_{k - 1}\end{matrix} ] + [ \begin{matrix}{x}_{c} \\ {y}_{c}\end{matrix} ] \qquad ( 5 )$$

The ground speed vtₖ of the preceding vehicle V2 can be calculated in accordance with the following formulas (6) and (7), and the acceleration atₖ of the preceding vehicle V2 can be calculated in accordance with the following formulas (8) and (9):

$${vt}_{k}^{′} = {vt}_{k - 1} + {at}_{k - 1} Δ t \qquad ( 6 )$$

$$[ \begin{matrix}{vxt}_{k} \\ {vyt}_{k}\end{matrix} ] = [ \begin{matrix}cos θ & - sin θ \\ sin θ & cos θ\end{matrix} ] [ \begin{matrix}{vxt}_{k}^{′} \\ {vyt}_{k}^{′}\end{matrix} ] \qquad ( 7 )$$

$${at}_{k}^{′} = {at}_{k - 1} \qquad ( 8 )$$

$$[ \begin{matrix}{axt}_{k} \\ {ayt}_{k}\end{matrix} ] = [ \begin{matrix}cos θ & - sin θ \\ sin θ & cos θ\end{matrix} ] [ \begin{matrix}{axt}_{k}^{′} \\ {ayt}_{k}^{′}\end{matrix} ] \qquad ( 9 )$$

In the formula (7), reference characters vxtₖ, vytₖ respectively represent the x and y components of the vector of the ground speed vtₖ. In the formula (9), reference characters axtₖ, aytₖ respectively represent the x and y components of the vector of the acceleration atₖ.

Specifically, the object route calculator 22 is configured to calculate, when the own vehicle V1 is turning while following the preceding vehicle V2 as the target object, the estimated object route PA2 in accordance with the formulas (4) to (9) assuming that the preceding vehicle V2 moves to draw a turning trajectory around the turning center point P1 of the own vehicle V1. This configuration makes it possible to reduce a deviation of the estimated object route PA2 calculated as a curved trajectory illustrated in, for example, FIG. 2 from an actual movement route of the preceding vehicle V2 as compared with a case of calculating the estimated object route PA2 as a linear trajectory, thus improving the prediction accuracy of the estimated object route PA2 of the preceding vehicle V2. This improvement of predicting the estimated object route PA2 of the preceding vehicle V2 enables improvement of calculating both (i) an intersection between the estimated own-vehicle route PA1 and the estimated object route PA2 and (ii) a TTC between the own vehicle V1 and the preceding vehicle V2, which refers to time that remains before the own vehicle V1 reaches the intersection, resulting in improvement of the accuracy of determining whether there will be a collision of the own vehicle V1 with the preceding vehicle V2.

The driving assistance apparatus 1 is configured to calculate the estimated own vehicle route PA1 of the own vehicle V1 in the three-dimensional coordinate system that is defined to have (i) the X axis representing distance X in the width direction of the own vehicle V1, (ii) the Y axis representing distance Y in the direction of travel of the own vehicle V1, and (iii) the T axis representing elapsed time T the current time (see FIG. 2).

Additionally, the driving assistance apparatus 1 is configured to determine whether a detected object is a preceding vehicle V2 in front of the own vehicle V1 and the own vehicle V1 is turning while following the preceding vehicle V2.

Then, the driving assistance apparatus 1 is configured to calculate, in response to determination that the detected object is the preceding vehicle V2 in front of the own vehicle V1 and the own vehicle V1 is turning while following the preceding vehicle V2, the estimated object route PA2 of the preceding vehicle V2 in the three-dimensional coordinate system as a turning trajectory around the turning center point P1 of the own vehicle V1.

This configuration therefore makes it possible to calculate the estimated object route PA2 of the turning preceding vehicle V2 as a curved route to accordingly reduce a deviation of the estimated object route PA2 from an actual movement route of the preceding vehicle V2 as compared with a case of calculating the estimated object route PA2, thus improving the accuracy of determining whether there will be a collision of the own vehicle V1 with the preceding vehicle V2.

While the illustrative embodiment of the present disclosure has been described herein, the present disclosure is not limited to the embodiment described herein or disclosed configurations, but includes various modifications and adaptations and/or alternations within the equivalent scope of the descriptions. Additionally, various combinations, embodiments, combinations to which only one element or plural elements have been added, or modified embodiments to which only one element or plural elements have been added are within the category or scope of the present disclosure,

The control apparatus, such as the collision determination ECU 20, and its control methods executable by the control apparatus in the present disclosure can be implemented by a dedicated computer including a memory and a processor programmed to perform one or more functions embodied by one or more computer programs.

The control apparatus and its control methods executable by the control apparatus in the present disclosure can also be implemented by a dedicated computer including a processor comprised of one or more dedicated hardware logic circuits.

The control apparatus and its control methods executable by the control apparatus in the present disclosure can further be implemented by a processor system comprised of a memory, a processor programmed to perform one or more functions embodied by one or more computer programs, and one or more hardware logic circuits.

The one or more programs can be stored in a computer-readable non-transitory storage medium as instructions to be carried out by a computer or a processor.

One or more components in the exemplary embodiment are not necessarily essential components except for (i) one or more components that are described as one or more essential components or (ii) one or more components that are essential in principle.

Specific values disclosed in the exemplary embodiment, each of which represents the number of components, a physical quantity, and/or a range of a physical parameter, are not limited thereto except that (i) the specific values are obviously essential or (ii) the specific values are essential in principle. The specific structural, functional, or positional relationship between components described in the exemplary embodiment is not limited thereto except for cases in which (1) the specific structural, positional, or functional relationship is described to be essential or (2) the specific structural or functional relationship is required in principle.

The present disclosure can be grasped as the following technological aspects:

### First Technological Aspect

A collision determination apparatus according to the first technological aspect is to determine whether there will be a collision of an own vehicle (V1) with an object detected by an object detection device (10). The collision determination apparatus of the first technological aspect includes an own-vehicle route calculator (21) configured to calculate, based on motion information on the own vehicle measured by at least one vehicular device installed in the own vehicle, an estimated first movement route of the own vehicle in a three-dimensional coordinate system. The three-dimensional coordinate system is defined to have a first axis representing distance in a width direction of the own vehicle, a second axis representing distance in a direction of travel of the own vehicle, and a third axis representing elapsed time from a current time. The collision determination apparatus of the first technological aspect includes an object route calculator (22) configured to calculate, based on a position of the detected object detected by the object detection device, an estimated second movement route of the detected object in the three-dimensional coordinate system, The collision determination apparatus of the first technological aspect includes a collision determiner (25) configured to determine whether there is an intersection between the estimated first movement route of the own vehicle and the estimated second movement route of the detected object to accordingly determine whether there will be a collision of the own vehicle with the detected object. The object route calculator is configured to, in response to determination that (i) the own vehicle is turning around a turning center point while following the detected object and (ii) the detected object is a preceding vehicle (V2) in front of the own vehicle, calculate, as the estimated second movement route of the detected object, a turning trajectory of the detected object around the turning center point of the own vehicle in the three-dimensional coordinate system.

### Second Technological Aspect

The collision determination apparatus of the second technological aspect, which depends from the first technological aspect, further includes an own-vehicle turning determiner (23) configured to determine whether at least one of a radius of curvature of a turning trajectory of the own vehicle and a rate of change of a steering angle of the own vehicle is smaller than or equal to at least one of corresponding thresholds to accordingly determine whether the own vehicle is turning.

### Third Technological Aspect

The collision determination apparatus of the third technological aspect, which depends from the first or second technological aspect, further includes a follow determiner (24) configured to determine whether a plurality of follow requirements are satisfied to accordingly determine whether the own vehicle is following the detected object. The plurality of follow requirements include a requirement indicative of whether the detected object is located on a predetermined region of a traffic lane on which the own vehicle is traveling. The predetermined region is surrounded by left-and right-side lane markers (WL, WR) of the traffic lane.

### Fourth Technological Aspect

In the collision determination apparatus of the fourth technological aspect, which depends from any one of the first to third technological aspects, the plurality of follow requirements include a requirement indicative of whether a lateral distance of the detected object relative to a turning trajectory of the own vehicle is within a width of the own vehicle.

### Fifth Technological Aspect

In the collision determination apparatus of the fifth technological aspect, which depends from any one of the first to fourth technological aspects, the plurality of follow requirements include a requirement indicative of whether (i) a ground speed of the detected object is higher than or equal to a predetermined speed threshold and (ii) an absolute angular difference between a future velocity vector of the own vehicle at a position adjacent to a current position of the detected object and a velocity vector of the detected object at the current position of the detected object is smaller than or equal to a predetermined angular-difference threshold.

### Sixth Technological Aspect

In the collision determination apparatus of the sixth technological aspect, which depends from any one of the first to fifth technological aspects, the plurality of follow requirements include a requirement indicative of whether a ground speed of the detected object is lower than a predetermined speed threshold. The follow determiner is configured to, in response to determination that the ground speed of the detected object is lower than the predetermined speed threshold, determine that the detected object is a stationary object and determine that the stationary object is a target that the own vehicle follows.

### Seventh Technological Aspect

In the collision determination apparatus of the seventh technological aspect, which depends from any one of the first to fifth technological aspects, the plurality of follow requirements include a requirement indicative of whether the detected object is a four-wheel vehicle or a motorcycle.

### Eighth Technological Aspect

The collision determination apparatus of the eighth technological aspect, which depends from the first technological aspect, further includes a turning follow determiner (23, 24) configured to determine whether the own vehicle is turning while following the detected object in accordance with (i) a steering angle of the own vehicle, (ii) a yaw rate of the own vehicle, and (iii) a speed of the own vehicle acquired based on the motion information on the own vehicle measured by the at least one vehicular device.

### Ninth Technological Aspect

In the collision determination apparatus of the ninth technological aspect, which depends from the eighth technological aspect, the turning follow determiner is configured to calculate a radius of curvature (R) of a turning trajectory of the own vehicle, calculate, based on the steering angle of the own vehicle, the rate of change of the steering angle, and calculate, based on the yaw rate of the own vehicle, the amount of change of the yaw rate. The turning follow determiner is configured to determine whether predetermined first to third set conditions based on (i) the radius of curvature, (ii) the rate of change of the steering angle, and (iii) the amount of change of the yaw rate are satisfied using predetermined first to third start thresholds to accordingly determine whether the own vehicle is turning. The first set condition is that an absolute value of the radius of curvature is smaller than or equal to the first start threshold. The second set condition is that an absolute value of the rate of change of the steering angle is smaller than or equal to the second start threshold. The third set condition is that the amount of change of the yaw rate is smaller than or equal to the third start threshold.

### Tenth Technological Aspect

In the collision determination apparatus of the tenth technological aspect, which depends from the ninth technological aspect, the turning follow determiner is configured to determine, after it is determined that the own vehicle is turning, that the own vehicle is not turning upon determination that at least one of a predetermined first reset condition and a predetermined second reset condition is satisfied based on (i) the radius of curvature radius and (ii) the rate of change of the steering angle. The first reset condition is that the absolute value of the rate of change of the steering angle is greater than a first end threshold. The second reset condition is that the absolute value of the radius of curvature is greater than a second end threshold.

### Eleventh Technological Aspect

In the collision determination apparatus of the eleventh technological aspect, which depends from the ninth technological aspect, the turning follow determiner is configured to
(A) Perform a first determination of whether the detected object is located on the estimated first movement route of the own vehicle as a result of at least one of (i) a lane determination of whether the detected object is located on a predetermined region of a traffic lane on which the own vehicle is traveling, the predetermined region being surrounded by left-and right-side lane markers of the traffic lane, and (ii) a lateral-distance determination of whether a lateral distance of the detected object relative to the turning trajectory of the own vehicle is within a width of the own vehicle
(B) Perform a second determination of whether (i) a ground speed of the detected object is higher than or equal to a predetermined speed threshold and (ii) an absolute angular difference between a future velocity vector of the own vehicle at a position adjacent to a current position of the detected object and a velocity vector of the detected object at the current position of the detected object is smaller than or equal to a predetermined angular-difference threshold
(C) Perform a third determination of whether the ground speed of the detected object is lower than the predetermined speed threshold;
perform a fourth determination of whether the detected object is a four-wheel vehicle or a motorcycle
(D) Determine whether the own vehicle is following the detected object in accordance with a result of each of the first to fourth determinations

### Twelfth Technological Aspect

A collision determination apparatus according to the twelfth technological aspect is to determine whether there will be a collision of an own vehicle with an object detected by an object detection device. The collision determination apparatus includes a memory (24B) storing a set of program instructions, and at least one processor (24A) configured to calculate, based on motion information on the own vehicle measured by at least one vehicular device installed in the own vehicle, an estimated first movement route of the own vehicle in a three-dimensional coordinate system. The three-dimensional coordinate system is defined to have a first axis representing distance in a width direction of the own vehicle, a second axis representing distance in a direction of travel of the own vehicle, and a third axis representing elapsed time from a current time. The at least one processor is configured to calculate, based on a position of the detected object detected by the object detection device, an estimated second movement route of the detected object in the three-dimensional coordinate system. The at least one processor is configured to determine whether there is an intersection between the estimated first movement route of the own vehicle and the estimated second movement route of the detected object to accordingly determine whether there will be a collision of the own vehicle with the detected object. The at least one processor is configured to calculate, in response to determination that (i) the own vehicle is turning around a turning center point while following the detected object and (ii) the detected object is a preceding vehicle in front of the own vehicle, a turning trajectory of the detected object around the turning center point of the own vehicle in the three-dimensional coordinate system as the estimated second movement route of the detected object.

### Thirteenth Technological Aspect

A program product according to the thirteenth technological aspect is to determine whether there will be a collision of an own vehicle with an object detected by an object detection device. The program product of the twelfth technological aspect Includes a non-transitory storage medium (20B), and program instructions stored in the non-transitory storage medium. The program instructions cause a processor (20A) to calculate, based on motion information on the own vehicle measured by at least one vehicular device installed in the own vehicle, an estimated first movement route of the own vehicle in a three-dimensional coordinate system. The three-dimensional coordinate system is defined to have a first axis representing distance in a width direction of the own vehicle, a second axis representing distance in a direction of travel of the own vehicle, and a third axis representing elapsed time from a current time. The program instructions cause the processor to calculate, based on a position of the detected object detected by the object detection device, an estimated second movement route of the detected object in the three-dimensional coordinate system. The program instructions cause the processor to determine whether there is an intersection between the estimated first movement route of the own vehicle and the estimated second movement route of the detected object to accordingly determine whether there will be a collision of the own vehicle with the detected object. The program instructions cause the processor to calculate, in response to determination that (i) the own vehicle is turning around a turning center point while following the detected object and (ii) the detected object is a preceding vehicle in front of the own vehicle, a turning trajectory of the detected object around the turning center point of the own vehicle in the three-dimensional coordinate system as the estimated second movement route of the detected object.

1. A collision determination apparatus for determining whether there will be a collision of an own vehicle with an object detected by an object detection device, the collision determination apparatus comprising:
an own-vehicle route calculator configured to calculate, based on motion information on the own vehicle measured by at least one vehicular device installed in the own vehicle, an estimated first movement route of the own vehicle in a three-dimensional coordinate system, the three-dimensional coordinate system being defined to have a first axis representing distance in a width direction of the own vehicle, a second axis representing distance in a direction of travel of the own vehicle, and a third axis representing elapsed time from a current time;
an object route calculator configured to calculate, based on a position of the detected object detected by the object detection device, an estimated second movement route of the detected object in the three-dimensional coordinate system; and
a collision determiner configured to determine whether there is an intersection between the estimated first movement route of the own vehicle and the estimated second movement route of the detected object to accordingly determine whether there will be a collision of the own vehicle with the detected object,
wherein:
the object route calculator is configured to, in response to determination that (i) the own vehicle is turning around a turning center point while following the detected object and (Il) the detected object is a preceding vehicle in front of the own vehicle, calculate, as the estimated second movement route of the detected object, a turning trajectory of the detected object around the turning center point of the own vehicle in the three-dimensional coordinate system.

2. The collision determination apparatus according to claim 1, further comprising:
an own-vehicle turning determiner configured to determine whether at least one of a radius of curvature of a turning trajectory of the own vehicle and a rate of change of a steering angle of the own vehicle is smaller than or equal to at least one of corresponding thresholds to accordingly determine whether the own vehicle is turning.

3. The collision determination apparatus according to claim 1, further comprising:
a follow determiner configured to determine whether a plurality of follow requirements are satisfied to accordingly determine whether the own vehicle is following the detected object,
the plurality of follow requirements including a requirement indicative of whether the detected object is located on a predetermined region of a traffic lane on which the own vehicle is traveling, the predetermined region being surrounded by left-and right-side lane markers of the traffic lane.

4. The collision determination apparatus according to claim 1, further comprising:
a follow determiner configured to determine whether a plurality of follow requirements are satisfied to accordingly determine whether the own vehicle is following the detected object,
the plurality of follow requirements including a requirement indicative of whether a lateral distance of the detected object relative to a turning trajectory of the own vehicle is within a width of the own vehicle.

5. The collision determination apparatus according to claim 1, further comprising:
a follow determiner configured to determine whether the own vehicle is following the detected object in accordance with whether a plurality of follow requirements are satisfied,
the plurality of follow requirements including a requirement Indicative of whether (i) a ground speed of the detected object is higher than or equal to a predetermined speed threshold and (ii) an absolute angular difference between a future velocity vector of the own vehicle at a position adjacent to a current position of the detected object and a velocity vector of the detected object at the current position of the detected object is smaller than or equal to a predetermined angular-difference threshold,

6. The collision determination apparatus according to claim 1, further comprising:
a follow determiner configured to determine whether the own vehicle is following the detected object in accordance with whether a plurality of follow requirements are satisfied,
the plurality of follow requirements including a requirement indicative of whether a ground speed of the detected object is lower than a predetermined speed threshold,
the follow determiner being configured to, in response to determination that the ground speed of the detected object is lower than the predetermined speed threshold, determine that the detected object is a stationary object and determine that the stationary object is a target that the own vehicle follows.

7. The collision determination apparatus according to claim 1, further comprising:
a follow determiner configured to determine whether the own vehicle is following the detected object in accordance with whether a plurality of follow requirements are satisfied,
the plurality of follow requirements including a requirement indicative of whether the detected object is a four-wheel vehicle or a motorcycle.

8. The collision determination apparatus according to claim 1, further comprising:
a turning follow determiner configured to determine whether the own vehicle is turning while following the detected object in accordance with (i) a steering angle of the own vehicle, (ii) a yaw rate of the own vehicle, and (iii) a speed of the own vehicle acquired based on the motion information on the own vehicle measured by the at least one vehicular device.

9. The collision determination apparatus according to claim 8, wherein:
the turning follow determiner is configured to:
calculate a radius of curvature of a turning trajectory of the own vehicle;
calculate, based on the steering angle of the own vehicle, the rate of change of the steering angle;
calculate, based on the yaw rate of the own vehicle, the amount of change of the yaw rate; and
determine whether predetermined first to third set conditions based on (i) the radius of curvature, (ii) the rate of change of the steering angle, and (iii) the amount of change of the yaw rate are satisfied using predetermined first to third start thresholds to accordingly determine whether the own vehicle is turning,
the first set condition being that an absolute value of the radius of curvature is smaller than or equal to the first start threshold,
the second set condition being that an absolute value of the rate of change of the steering angle is smaller than or equal to the second start threshold,
the third set condition being that the amount of change of the yaw rate is smaller than or equal to the third start threshold.

10. The collision determination apparatus according to claim 9, wherein:
the turning follow determiner is configured to determine, after it is determined that the own vehicle is turning, that the own vehicle is not turning upon determination that at least one of a predetermined first reset condition and a predetermined second reset condition is satisfied based on (i) the radius of curvature radius and (ii) the rate of change of the steering angle,
the first reset condition being that the absolute value of the rate of change of the steering angle is greater than a first end threshold,
the second reset condition being that the absolute value of the radius of curvature is greater than a second end threshold.

11. The collision determination apparatus according to claim 9, wherein the turning follow determiner is configured to:
perform a first determination of whether the detected object is located on the estimated first movement route of the own vehicle as a result of at least one of (i) a lane determination of whether the detected object is located on a predetermined region of a traffic lane on which the own vehicle is traveling, the predetermined region being surrounded by left-and right-side lane markers of the traffic lane, and (ii) a lateral-distance determination of whether a lateral distance of the detected object relative to the turning trajectory of the own vehicle is within a width of the own vehicle;
perform a second determination of whether (i) a ground speed of the detected object is higher than or equal to a predetermined speed threshold and (ii) an absolute angular difference between a future velocity vector of the own vehicle at a position adjacent to a current position of the detected object and a velocity vector of the detected object at the current position of the detected object is smaller than or equal to a predetermined angular-difference threshold;
perform a third determination of whether the ground speed of the detected object is lower than the predetermined speed threshold;
perform a fourth determination of whether the detected object is a four-wheel vehicle or a motorcycle; and
determine whether the own vehicle is following the detected object in accordance with a result of each of the first to fourth determinations.

12. A collision determination apparatus for determining whether there will be a collision of an own vehicle with an object detected by an object detection device, the collision determination apparatus comprising:
a memory storing a set of program instructions; and
at least one processor configured to execute the program instructions to:
calculate, based on motion information on the own vehicle measured by at least one vehicular device installed in the own vehicle, an estimated first movement route of the own vehicle in a three-dimensional coordinate system, the three-dimensional coordinate system being defined to have a first axis representing distance in a width direction of the own vehicle, a second axis representing distance in a direction of travel of the own vehicle, and a third axis representing elapsed time from a current time;
calculate, based on a position of the detected object detected by the object detection device, an estimated second movement route of the detected object in the three-dimensional coordinate system; and
determine whether there is an intersection between the estimated first movement route of the own vehicle and the estimated second movement route of the detected object to accordingly determine whether there will be a collision of the own vehicle with the detected object,
wherein:
the at least one processor is configured to:
calculate, in response to determination that (i) the own vehicle is turning around a turning center point while following the detected object and (ii) the detected object is a preceding vehicle in front of the own vehicle, a turning trajectory of the detected object around the turning center point of the own vehicle in the three-dimensional coordinate system as the estimated second movement route of the detected object.

13. A program product for determining whether there will be a collision of an own vehicle with an object detected by an object detection device, the program product comprising:
a non-transitory storage medium; and
program instructions stored in the non-transitory storage medium,
the program instructions causing a processor to:
calculate, based on motion information on the own vehicle measured by at least one vehicular device installed in the own vehicle, an estimated first movement route of the own vehicle in a three-dimensional coordinate system, the three-dimensional coordinate system being defined to have a first axis representing distance in a width direction of the own vehicle, a second axis representing distance in a direction of travel of the own vehicle, and a third axis representing elapsed time from a current time;
calculate, based on a position of the detected object detected by the object detection device, an estimated second movement route of the detected object in the three-dimensional coordinate system; and
determine whether there is an intersection between the estimated first movement route of the own vehicle and the estimated second movement route of the detected object to accordingly determine whether there will be a collision of the own vehicle with the detected object,
wherein:
the program instructions cause the processor to calculate, in response to determination that (i) the own vehicle is turning around a turning center point while following the detected object and (ii) the detected object is a preceding vehicle in front of the own vehicle, a turning trajectory of the detected object around the turning center point of the own vehicle in the three-dimensional coordinate system as the estimated second movement route of the detected object.
